(19) United States
(12) Patent Application Publication
(10) Pub. No.: US 2025/0281876 A1
(43) Pub. Date: Sep. 11, 2025

(54) DECONTAMINATING MATERIALS AND METHODS OF MAKING AND USING SAME

(71) Applicants: TELEDYNE FLIR DEFENSE, INC., North Billerica, MA (US); University of Massachusetts, Westborough, MA (US)

(72) Inventors: Jennifer L. Poole, Delmont, PA (US); Ann Elizabeth Donnelly, Irwin, PA (US); Jay Hoon Park, Newton Highlands, MA (US); Taiyo Yamaguchi, Arlington, MA (US)

(21) Appl. No.: 19/071,972

(22) Filed: Mar. 6, 2025

Related U.S. Application Data
(60) Provisional application No. 63/563,104, filed on Mar. 8, 2024.
(60) Provisional application No. 63/563,339, filed on Mar. 9, 2024.

(51) Int. Cl. B01D 53/82; A62D 5/00; A62D 7/00; B01D 39/16; B01D 46/00; B01D 46/54; B01D 53/48; B01D 53/54; B01J 20/22; B01J 20/28; B01J 20/30; B01J 20/32; B05B 5/00; D01D 5/00; D04H 1/413; D04H 1/4309; D04H 1/4382; D04H 1/728

(52) U.S. Cl. CPC B01D 53/82; A62D 5/00; A62D 7/00; B01D 39/1623; B01D 46/0027; B01D 46/546; B01D 53/48; B01D 53/54; B01J 20/226; B01J 20/28028; B01J 20/3007; B01J 20/3042; B01J 20/321; B01J 20/3214; B01J 20/3265; B01J 20/3293; B05B 5/005; D01D 5/0038; D04H 1/413; D04H 1/4309; D04H 1/43838; D04H 1/728; B01D 2239/025; B01D 2239/0407; B01D 2239/0631; B01D 2239/10; B01D 2239/1258; B01D 2239/1291; B01D 2253/204; B01D 2257/306; B01D 2257/40; B01D 2257/556; B01D 2258/06; D10B 2321/06; D10B 2401/00; D10B 2505/04

(57) ABSTRACT

Decontaminating materials and methods of making and using the same are provided. The material comprises a network comprising electrospun polymeric nanofibers and at least 50 grams of metal organic framework (MOF) microparticles per m² of the network based on the entire area of the network. A composition of the polymeric nanofibers comprises a hydroscopic polymer. An area of the material is defined by an outer surface of the network. The MOF microparticles are retained between the polymeric nanofibers in the network and are configured to decontaminate a chemical threat agent in contact with the material.

### CROSS-REFERENCE

The Subject application claims priority to U.S. Provisional Application No. 63/563,104 filed Mar. 8, 2024 and to U.S. Provisional Application No. 63/563,339 filed Mar. 9, 2024, the entire contents of each is hereby incorporated by reference.

### GOVERNMENT SUPPORT

This invention was made with government support under Contract No. N6600121C4009 awarded by the Department of Defense, Defense Advanced Research Projects Agency. The government has certain rights in the invention.

### FIELD

This disclosure relates generally to materials and methods for producing the materials, and decontaminating chemical agents with materials.

### BACKGROUND

The current landscape of potential chemical and biological (CB) threat agents encompasses a wide variety of ever evolving, broad acting, highly pathogenic, and immediately lethal threats. These agents can enter the body via multiple pathways, including through the skin, airway, eyes, and the gastrointestinal tract.

Currently available individual personal protection equipment (PPE) against CB threat exposure may include multi-layered suits constructed from impermeable barrier materials, activated sorbents, full-face respirator masks, boots and gloves. These protective gear and postures are typically specifically tailored based on a designated threat identity, chemical or biological, and the level of threat the wearer is expected to encounter. Accordingly, the wearer typically must have prior knowledge of what threat agents they may encounter, which is not always possible. Furthermore, once the appropriate equipment and posture are selected, existing gear can be bulky, uses static barrier materials such as, for example, activated carbon and/or dense butyl rubber, difficult to don, and severely restricting to the operator's performance due to poor moisture vapor transport and high thermal burden. For example, currently available garments and canisters for gas masks rely on carbon-based sorbent technology for protection. These sorbents have limited capacity and are easily fouled over time. Additionally, some garments for bioprotection may contain no inherent antimicrobial technology and instead rely entirely on the use of multiple layers of fluid-resistant, impermeable barrier materials to prevent wearer exposure. This lack of active decontamination capability within existing CB ensembles inherently limits the lifetime of these garments and puts wearers at risk for transfer hazards and secondary exposure during doffing. The discarded garment itself may present a hazard of threat propagation, complicating the logistics of CB operations.

Despite advances in the CB defense over decades, current PPE solutions add logistical, mobility, and thermal challenges which place warfighter health and mission success at risk.

### SUMMARY

One non-limiting aspect of the present disclosure is directed to a material comprising a network and at least 50 grams, or in certain embodiments at least 70 grams, of metal organic framework (MOF) microparticles per square meter (m²) of the network based on the entire area of the network. The network comprises electrospun polymeric nanofibers. The polymeric nanofibers comprise a hygroscopic polymer. The network comprises an outer surface. An area of the active layer is defined by the outer surface of the network. The MOF microparticles are configured to decontaminate a chemical threat agent in contact with the active layer. The MOF microparticles are retained between the polymeric nanofibers in the network.

Another non-limiting aspect of the present disclosure is directed to a method for producing an active layer or material. The active layer or material is configured to decontaminate a chemical threat agent in contact with the active layer. The method comprises depositing the material onto a collector. Depositing the material comprises electrospinning, at a first voltage in a range of 15 kilovolts (kV) to 50 kV, a first mixture onto the collector and electrospraying, at a second voltage in a range of 15 kV to 50 kV, a second mixture onto the collector concurrently with electrospinning the first mixture. The first mixture comprises polyvinyl alcohol (PVA) having an average molecular weight in a range of 20,000 g/mol to 300,000 g/mol. The first mixture further comprises water. The second mixture comprises MOF microparticles and a water miscible solvent. At least one of electrospinning the first mixture or electrospraying the second mixture is an air-assisted process.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 is a schematic representation an electrospinning process according to various non-limiting embodiments of the present disclosure. The process can provide exceptionally small diameters (10-100 nm), high specific surface area (10-1000 m²/g), select porosity due to interconnected pore structures, and/or ideal template for nanomaterials.

FIG. 2 is a schematic representation of an LVAP testing method according to various non-limiting embodiments of the present disclosure.

FIG. 3 is a schematic representation a breakout of the configuration of different layers in the LVAP test set up for agent repellency testing.

FIG. 4 is an image of a water vapor permeability cup (thwingalbert.com) with a specimen between neoprene rings, and a Teflon ring against the top flange ring according to various non-limiting embodiments of the disclosure.

FIG. 5A is a schematic representation of a material according to various non-limiting embodiments of the disclosure.

FIG. 5B is a schematic representation of the material of FIG. 5A illustrating dimensions.

FIG. 6 is a graph of dose extraction data according to various non-limiting embodiments of the disclosure. Dose Extraction of UiO-66-NH₂ spiked with DEVX (also known as Diethyl VX or DIPR-Amiton; CAS: 219662-56-3) to verify maintained activity post laundering with or without the inclusion of a rinse cycle. All mitigant samples showed good activity post laundering.

FIG. 7 is a flow diagram of a method for producing a material according to various non-limiting embodiments of the present disclosure.

FIG. 8 is a schematic representation of an air-assisted process according to various non-limiting embodiments of the present disclosure.

FIG. 9 is a schematic representation of a co-spin-spray system for producing an active layer according to various non-limiting embodiments of the present disclosure.

FIG. 10 shows images of an example of a co-spin-spray system according to various non-limiting embodiments of the present disclosure.

FIG. 11 shows images during a process for production of nylon/UiO-66-NH₂ layer-by-layer composite manufactured from co-spin/spray of nylon in formic acid and UiO-66-NH₂ in NMP (N-Methyl-2-pyrrolidone) without air control assist on a Nomex knit support material according to various non-limiting embodiments of the present disclosure.

FIGS. 12A-12C show a process for production of nylon/UiO-66-NH₂ layer-by-layer composite manufactured from co-spin/spray of nylon in formic acid and UiO-66-NH₂ in NMP with air control assist on a Nomex knit support material according to various non-limiting embodiments of the present disclosure. FIG. 12A is a visual image of a co-spin/spray composite.

FIG. 12B is an image via optical microscope of the co-spin/spray composite. FIG. 12C is an image via optical microscope of the Nomex knit substrate.

FIG. 13 is a graph showing DFP (diisopropylfluorophosphate) headspace absorption of the Nylon-UiO-66-NH₂ co-spin/spray composite pre- and post-washing according to various non-limiting embodiments of the present disclosure.

FIG. 14 is an image of a nylon-UiO-66-NH₂ co-spin/spray composite according to various non-limiting embodiments of the present disclosure. The nylon-UiO-66-NH₂ co-spin/spray composite was manufactured from formulations of nylon/formic acid and UiO-66-NH₂/IPA (Isopropyl alcohol).

FIGS. 15A-15C are Images of PVA-UiO-66-NH₂ co-spin/spray composites manufactured from formulations of PVA/water and UiO-66-NH₂/IPA according to various non-limiting embodiments of the present disclosure. FIG. 15A is an image of co-spin/spray composite manufactured without traverse collection. FIG. 15B is an image of a co-spin/spray composite manufactured with traverse collection (sample MK19). FIG. 15C is a SEM micrograph of surface of PVA-UiO-66-NH₂ co-spin/spray composite that showed high fiber content entangled with high UiO-66-NH₂ loading.

FIGS. 16A and 16B are graphs showing results of CB mitigant functional testing of co-spin/spray composites of PVA/UiO-66-NH₂ according to various non-limiting embodiments of the present disclosure. FIG. 16A illustrates a graph of D/E liquid decontamination testing of composite materials vs. pristine UiO-66-NH₂ powder against 10 g/m² challenge of DEVX, V-series nerve agent simulant. FIG. 16B is a graph of gas-phase headspace absorption of 1 μL of DFP, G-series nerve agent simulant, performance of co-spin/spray composite vs. SOA liner for 0.5 in² area samples.

FIG. 17 is a graph illustrating results of CB mitigant functional testing of co-spin/spray composites of PVA/UiO-66-NH₂. (Composite P) vs. PPE carbon cloth standards according to various non-limiting embodiments of the present disclosure. Carbon cloth loses gas absorption efficiency over time once it is exposed to air. The “Carbon Cloth Historical” data represents carbon cloth testing as it was when freshly opened. The “Carbon Cloth” represents that sample, now aged, but tested side by side with Composite P. Composite P was a layered combination of MKs 19 & 20 at a total UiO-66-NH₂ load of approximately 150 g/m².

FIGS. 18A and 18B illustrate images of dusting of active layers according to various non-limiting embodiments of the present disclosure. Co-spin/spray materials demonstrated varying amounts of MOF “dusting” when a finger was wiped across the surface of the composite. Dusting was found to relate to the polymer:MOF ratios of the composite. FIG. 18A is an image of PVA/UiO-66-NH₂ composition ratio of 20/80, minimal MOF dusting. FIG. 18B is an image of PVA/UiO-66-NH₂ composition ratio of 10/90, significant MOF dusting.

FIGS. 19A and 19B illustrate wrinkling of active layers according to various non-limiting embodiments of the present disclosure. Co-spin/spray materials demonstrated wrinkling of the substrate support in some instances. Support deformation was found to relate to the weight and composition of the substrate in comparison with the deposition weight of the polymer-MOF composite. FIG. 19 A illustrates Heavier Nomex nonwoven (1.5 oz/yd²) substrate produced samples with minimal wrinkling. FIG. 19B illustrates Lightweight Nomex nonwoven (0.8 oz/yd²) produced samples with significant wrinkling of the support material.

FIGS. 20A-20C illustrate layering of active layers according to various non-limiting embodiments of the present disclosure. Co-spin/spray materials demonstrated layering of the composite mat in some instances. The layered morphology was found to be a function of manufacturing time and MOF loading. FIG. 20A is an image of a single-layered PVA/UiO-66-NH₂ co-spin spray mats manufactured with up to 90 g/m² MOF and a 1:4 ratio of PVA:MOF.

FIG. 20B is an image of an example of suboptimal layered co-spin/spray composition, sample contained several thin layers that were closely associated. FIG. 20C is an image of an example of suboptimal layered co-spin/spray composition, sample contained two thick layers that were closely associated.

FIGS. 21A-21C are images illustrating thermally cured active layers according to various non-limiting embodiments of the disclosure. Stabilization of PVA/UiO-66-NH₂ co-spin/spray mats via thermal curing. FIG. 20A is an image of a pristine sample, untreated and as-spun. FIG. 20B is an image of samples thermally cured for 1 hour at 140° C. FIG. 20C is samples thermally cured for 1 hour at 140° C. followed by laundering under standard conditions.

FIGS. 22A and 22B are SEM images of PVA/UiO-66-NH₂ co-spin/spray mats according to various non-limiting embodiments of the present disclosure. FIG. 22A is SEM images of mats post thermal curing. FIG. 22B is SEM images of mats post thermal curing, post-laundering, ambient dry.

FIG. 23 is a graph illustrating air permeability of thermally cured active layers according to various non-limiting embodiments of the present disclosure. Air permeability of PVA/UiO-66-NH₂ co-spin/spray mats as prepared, heat treated, and post-laundering (up to 6 laundering cycles) are shown.

FIGS. 24A and 24B are graphs illustrating decontamination of thermally cured active layers according to various non-limiting embodiments of the present disclosure. FIG. 24A illustrates CB mitigant function of PVA/UiO-66-NH₂ co-spin/spray mats as prepared, heat treated, and post-laundering in DFP headspace absorption. FIG. 24B illustrates CB mitigant function of PVA/UiO-66-NH₂ co-spin/spray mats as prepared, heat treated, and post-laundering in DEVX D/E.

FIG. 25 is photographs of crosslinked active layers according to various non-limiting embodiments of the present disclosure. Disks of PVA-PAA (Polyacrylic acid) and PVA-PAA/UiO-66-NH₂ before (as spun) and after thermal crosslinking (heat treated), pre- and post-exposure to either room temperature water or water at 95° C. are shown.

FIGS. 26A and 26B show SEM images of crosslinked active layers according to various non-limiting embodiments of the present disclosure. SEM images of PVA-PAA/UiO-66-NH₂ pre- and post-exposure to water at room temperature or 95° C. for samples shown. FIG. 26A illustrates before thermal crosslinking (as spun). FIG. 26B illustrates after thermal crosslinking (heat treated at 140° C., 1 hour),

FIG. 27 is images of active layers produced with air-assisted methods according to various non-limiting embodiments of the present disclosure. In the top row, macroscopic optical photos o of PVA/MOF electrospin/spray process with air vs. no-air for each active layer are provided. In the bottom row, microscopic SEM micrographs of the PVA/MOF electrospin/spray process with air vs. no-air for each active layer are provided.

FIG. 28 is images of materials according to various non-limiting embodiments of the present disclosure. Images of the free-standing, non-layered, non-wrinkled PVA/UiO-66-NH₂ co-spin/spray sample prepared for IV&V testing are provided.

FIG. 29 shows elements of an outer layer according to various non-limiting embodiments of the present disclosure.

FIG. 30 is an image of side views of examples of composite materials according to various non-limiting embodiments of the present disclosure.

FIG. 31 is a graph illustrating LVAP permeation of the composite materials of FIG. 30.

FIG. 32 is a schematic representation of a Franz cell apparatus according to various non-limiting embodiments of the present disclosure.

FIG. 33 is a graph illustrating VX penetration through swatches according to various non-limiting embodiments of the present disclosure. Franz cell analysis of VX penetration through ISPS and SOA (State of the Art) swatches on rabbit skin. Data denotes quantity of VX extracted from the buffer solution beneath the swatch/skin layers and represents the amount of VX that would theoretically enter the bloodstream as a result of permeation.

FIG. 34 is a graph illustrating VX distribution by layer post Franz cell analysis according to various non-limiting embodiments of the present disclosure. Swab represents remaining contact hazard. Swatch includes all agent held within the garment. Skin represents agent that has passed through the garment swatch and is held within the skin but has not yet permeated beyond to the buffer solution below.

FIGS. 35A and 35B are graphs illustrating addition layer by layer detail of the samples of FIG. 34. FIG. 35A illustrates data that was analyzed by layer. The “top” layer served as an omniphobic repellent layer while the “bottom” layer served as sorbent or decontaminant for the agent challenge. FIG. 35B illustrates VX penetration to skin and the large difference of agent skin sequestration for the SOA vs ISPS samples demonstrated the benefit of using decontaminant within the PPE over sorbent to reduce the overall agent load transferred to the skin.

FIG. 36 is a graph illustrating AVLAG permeation of swatches according to various non-limiting embodiments of the present disclosure.

FIG. 37 is a graph showing AVLAG permeation of swatches according to various non-limiting embodiments of the present disclosure.

FIG. 38 shows a mechanical testing apparatus (Gelbo Flex test apparatus) and its test procedure according to various non-limiting embodiments of the present disclosure.

### DETAILED DESCRIPTION

In one general aspect, the present disclosure provides protective material components, materials, and filters capable of comprehensive protection with greater capacity, increased comfort, and/or reduced hazard during and following doffing. These engineered materials were designed to leverage broad-spectrum material protection solutions to address the expansive set of potential CB threats in a single protective ensemble. The use of chemically and biologically reactive barrier materials to increase PPE function and minimize burden represents a paradigm shift from the current PPE offered in the field.

The present disclosure provides materials and methods for producing the materials, and decontaminating chemical agents with materials, which may increase PPE function and minimize burden to a warfighter. The material comprises a network and at least 50 grams of metal organic framework (MOF) microparticles per square meter (m²) of the network based on the entire area of the network. The network comprises electrospun polymeric nanofibers. The polymeric nanofibers comprise a hygroscopic polymer. An area of the material is defined by the outer surface of the network. The MOF microparticles are configured to decontaminate a chemical threat agent in contact with the material. The MOF microparticles are retained between the polymeric nanofibers in the network.

The materials according to the present disclosure may be incorporated into various articles. For example, the articles can comprise garments (e.g., protective materials such as, for example, suits, masks, gloves, tents), filtration equipment (e.g., air cleaning applications, air canisters for masks), decontamination equipment (e.g., air and/or liquid cleaning applications), chemical and particle sequestration equipment (e.g., for the purposes of cleaning air/gas or liquid, or for the purpose of capture of chemical or biological material for concentration or later sample removal purposes), sensor equipment (e.g., for material sequestration or transformation based on interaction of analyte with the immobilized reactant).

In one general aspect, the present disclosure is directed to a novel reactive material comprising an active layer, also referred to as a CB mitigant layer herein, capable of high efficiency self-decontamination upon exposure to chemical and/or biological threat agents. The active layer comprises a complex network of nanofibers and a broad spectrum chemical and/or biological threat agent mitigant. Upon exposure to a chemical and/or biological threat agent, permeation of the threat agent into the complex network of nanofibers facilitates exposure of the agent to the threat agent mitigant. Selected agent mitigants included novel sorbents, catalysts, antimicrobials, and polymer technologies. Due to the diversity of agent classes targeted for protection, broad spectrum mitigants may be used to keep the overall garment burden low. Mitigants were targeted that exhibited high efficiency and were capable of class-level or multi-class agent sequestration and detoxification. A composite incorporating the active layer in conjunction with an omniphobic outer layer showed protection against VX in live agent testing superior to the current state-of-the art used in the field. Not only does this novel material prevent against agent penetration but further testing showed the agent breakdown products from decontamination may have a significantly reduced toxicity.

According to another general aspect, the present disclosure is directed to an active material that need not or does not include other layers or materials and that is cable of high efficiency self-decontamination upon exposure to chemical threat agents.

As used herein, the term “decontamination” can refer to any process wherein a threat agent is chemically transformed, such as by decomposition, neutralization, and/or degradation, to substantially reduce toxicity material and/or is physically sorbed thereon or trapped therein.

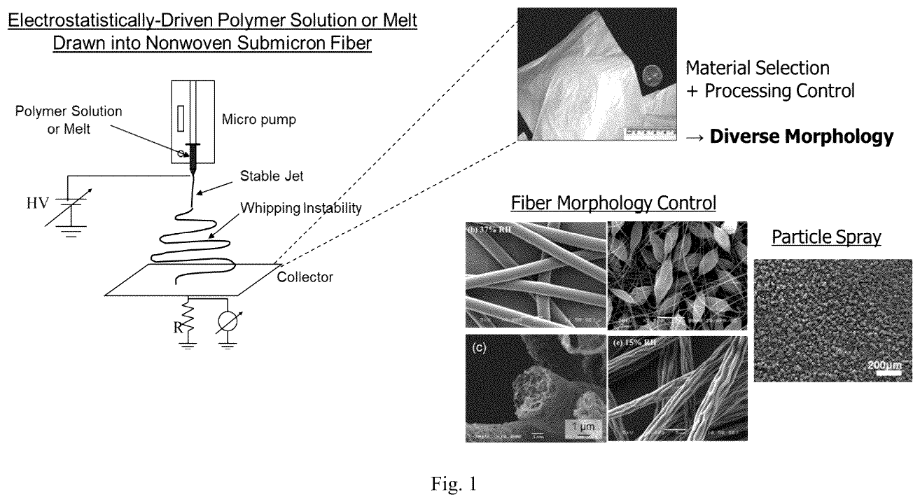

Typical commercial synthetic fibers used in garment materials have diameters on the order of 10-100 microns (μm). Fibers produced from an electrospinning process, however, are typically ultra-fine, can achieve diameters less than 1 μm, and have been referred to as “nanofibers”. The diameter of the fibers can be measured with a scanning electron microscope. Although there are several other fiber processing techniques known to form 1-10 μm (e.g., meltblowing), electrospinning as shown in FIG. 1 can produce submicron fibers consistently and with uniquely controllable morphology. Such a unique geometrical feature can lend itself to i) high specific surface area on the order of 10-1000 m²/g; ii) lightweight yet robust material especially for use in filtration and wipes; and iii) tortuous pathways to trap liquid agent while blocking sub-micron size particles from entering or exiting the material. In addition, the high specific surface area of the electrospun fiber can result in higher surface presentation of polymer inclusion material per surface area. Such traits can led to successful usage of electrospun mats as highly sensitive and selective electrochemical and gas sensors. Formation of electrospun fibers with hierarchical morphological control (i.e., porous surface, beads-on-string, textured surface), can lead to control over hydrophobicity and material robustness. Combinations of the aforementioned features with control over a wide range of morphologies can lead to successful application of electrospun mats as liquid filters, air filters, separators, and membranes.

Early utility of these materials had been limited to lab-scale. This may have been, in part, due to the limited production rate of electrospinning. However, recent years have seen increased activities to up-scale electrospinning to commercial scale. The emergence of the recent COVID-19 pandemic had also seen the rise of re-usable nano-fiber masks for high efficiency (>95%) filtration via electrospinning in the commercial sector. As such, electrospinning was targeted by the inventors as a promising manufacturing method to produce active layer materials of the present disclosure. High surface area fibers produced via electrospinning, combined with the sorption/decontamination properties of inorganic CB mitigants provided an attractive solution to the difficult task of generating highly efficient CB mitigant materials of reduced weight and burden.

In various non-limiting embodiments, the present disclosure provides an extended co-electrospin-electrospray manufacturing process which impregnates membranes of nanofibers with microparticles. A co-electrospin-electrospray approach was employed which could support moderate mitigant loadings in the range of hundreds of grams of mitigant per square meter of co-formed material layer.

In the mitigant-polymer co-electrospinning-electrospraying (co-spin/spray) approach, the mitigant and polymer were electrosprayed and electrospun into a layer-by-layer composite, respectively and separately. In this method, the mitigant was not pre-dispersed within the polymer but was electrosprayed from solvent in between layers of electrospun polymer filter. The fact that the mitigant was not integrated within the fibers meant that larger mitigant particles could be used (on the order of tens of μm in diameter) which ultimately should result in improved retention between the fiber mats. Likewise, removing the mitigant from the fiber should result in improved mechanical integrity of the fiber and ultimately more effective filtration and durable composite materials.

### Material Properties and Analysis

Any reference to various properties of the materials, or layers thereof, of the present disclosure, and/or layers thereof are made with respect to the following definitions and/or test methods associated therewith.

Abrasion—The ability of a material to resist abrasion assessed using ASTM D3884. H-18 wheels with 250 g added weight was used. Samples were tested in triplicate.

Acute Toxicity Testing—Dermal (in vitro)—The dermal toxicity of individual material components used in the composite swatches were determined using two tests: the MatTek EpiDerm Skin Irritation Test and the Direct Peptide Reactivity Assay (DPRA). The skin irritation test assesses skin tissue viability (via MTT reduction) after material exposure, with a final classification of non-irritating or irritating. DPRA is a method for classifying whether a material is a sensitizer or not. The test quantifies cysteine or lysine-containing peptide depletion following 24 h material exposure. MTT reduction is an assay of skin viability based on intracellular reduction of 3-(4, 5-dimethylthiazol-2-yl)-2, 5-diphenyltetrazolium bromide (MTT) to purple formazan granules.

Adsorption Isotherm Analysis—Gravimetric uptake tests were conducted by placing sorbent samples in a suspended hangdown basket using a Cahn Instruments Model D200 microbalance. Automated switching valves and a temperature-controlled saturator cell were used to flow either clean or chemical-laden air to the sample at a predetermined concentration. The transient mass profile was monitored for the equilibrium condition.

Aerosol Vapor Liquid Assessment Group (AVLAG)—Liquid challenge/vapor penetration testing (using AVLAG cells) was performed on composite samples following TOP 08-2-501A. Samples were loaded into AVLAG cells and directly dosed with 10 g/m² agent (GD and HD) and monitored for vapor penetration at 2, 6, and 24 h timepoints. Following the test, cells were disassembled, and samples assessed in a residual contact test.

Air Permeability—Air permeability of material, mitigant and composite swatches were evaluated following the ASTM D737 test method. The rate of air flow through a known area of material was measured. Samples were not pre-conditioned at 21+/−1° C. (70+/−2° F.) and 65+/−2% relative humidity; however, they were tested at those conditions most of the time. An SDL Atlas model M021A air permeability tester was used. Instrument parameters were pressure at 200 Pascals (Pa) and the test area was 20 cm². Readings from the instrument were taken in l/m²/s and/or cfm. The specimen number varied depending on the amount of available material.

BET Surface Area Analysis—Surface area is calculated using the Brunauer-Emmett-Teller (BET) theory using a Micromeritics Gemini VII Surface Area Analyzer. To remove water and other bound molecules, mitigant samples were first dried and degassed by heating samples to 200° C. for one hour while purging with nitrogen gas using the Micromeritics FlowPrep 060 accessory. The analysis involves pulling a vacuum on the degassed sample while cooling with liquid nitrogen to analyze over the relative pressure range of 0.05-0.25 P/P₀, then introducing an absorbate gas to the sample. A carbon reference standard with a surface area of 21.0+/−0.75 m²/g was measured for instrument validation. Select samples were analyzed for pore-size distributions using the Non-Local Density Functional Theory (NLDFT) model for carbon slit pore geometry provided by ASAP 2020.

Dose-Extraction (D/E)—Dose-Extraction measured the capability of a mitigant to degrade a standard amount of chemical warfare simulant or agents over a given period, typically 24 h. The CWAs or simulants tested included DEVX, 2-CEPS (2-chloroethyl phenyl sulfide), VX, HD, GD, and GB. Mitigants were dosed with 1 μL of a simulant (i.e., DEVX) on 10 mg of powder mitigant, or an 8 mm diameter circle of composite material. After 24 h incubation (in a sealed vial to minimize evaporation), samples were extracted using 1 mL of chloroform containing an internal standard (0.3 mM tributyl phosphate), filtered (0.45 μm nylon syringe filter), and analyzed via GCMS. A negative (simulant only) control was included to assess simulant recovery and potential simulant self-degradation. UiO66-NH₂ powder served as a positive control (10 mg) which typically decontaminated 90% of the DEVX dosed, to monitor daily fluctuations in execution and instrumentation, and ensure that DEVX and TBP (Tributyl phosphate) signals were reliable for the evaluated samples.

Filtration Efficiency—Physical Particles—Filtration efficiency (FE) testing was done using a TSI 8130A automated filter tester based on NIOSH standard with an aerosol flow of 2% NaCl solution at a flow rate of 85 l/min. The pressure drop (PD) Pa, penetration % from which the FE % (100−Penetration %) were obtained, as described in Equation (1) below:

$$Particle Filtration Efficiency \% = 1 - \frac{Average Downstream Concentration}{Average Upstream Concentration} \times 100 \% \qquad ( 1 )$$

Additional testing was done using dioctyl phthalate (DOP) at particle sizes ranging from 0.03-0.40 μm to determine what particle size was most penetrating.

Filtration Efficiency—Viral Particles—Aerosol filtration efficiency testing (AFET) to simulate viral particles was carried out using aerosolized Bacteriophage PR772 (particle size=60 nm) or fluorescent particles (2-4 μm). Penetration % and efficiency % (described in above method) were measured by plaque assay (phage) or particle counting and fluorescence (fluorescent particles).

Fourier-Transform Infrared (FT-IR) Spectroscopy—A Thermo Scientific Nicolet iS5 spectrometer equipped with an iD5 ATR accessory was used to acquire Fourier-transform infrared (FT-IR) spectra for qualitatively evaluating the transition of polymer precursors into active mitigant.

Franz Cell Diffusion—To assess the effectiveness of composite swatches to inhibit/decontaminate chemical agent penetration through skin, Franz diffusion cell studies were conducted. Briefly, rabbit skin was covered by composite swatches and dosed with VX on the outer surface of the swatch. Penetration and decontamination were assessed after exposure for 24 h.

### Gas Chromatography/Mass Spectrometry (GC/MS)

### Instrumentation

Agilent 7890A GC/5975C MSD
Agilent 8890 GC/5977B MSD/7697A HS sampler

### PPB_Scan_Splitless.MFi

Used for DEVX, DFP, 2-CEPS dose/extraction experiments when expected concentrations are low (e.g. when decontamination is effective) Approximate RTs: DFP 7.41 min, 2-CEPS 12.08 min, TBP (IS) 13.39 min, DEVX 14.45 min
Column: DB-35 ms Ultra Inert 30 m×250 μm×0.25 μm
Injection type: Splitless
Injection volume: 1 μL
GC Temp program: 50° C. 2 min, 10° C./min to 100° C., 20° C./min to 300° C., hold 300° C. 1 min
Detector: MS (35-300 m/z)
Solvent delay: 4 min

### PPB_Scan_20Split.M

Same method as above, use for higher concentrations of DEVX/DFP
Injection type: Split 20:1

### DFP1_short10split.M or DFP1_short100split.M

Shortened method for analyzing DFP dose/extraction experiments using the ALS
Approximate RTs: DFP 3.98 min, TBP 8.35 min
Column: DB-35 ms Ultra Inert 30 m×250 μm×0.25 μm
Injection type: Split 10:1 or 100:1
Injection volume: 1 μL
GC Temp program: 80° C. 2 min, 25° C./min to 250° C., hold 250° C. 1 min
Detector: MS (35-500 m/z)
Solvent delay: 3 min

### DFP-HHS-short1_300split.M

Used for DFP headspace when dosing 1 μL neat DFP in 20 mL vials
Approximate RTs: DFP 3.66 min
Column: DB-35 ms Ultra Inert 30 m×250 μm×0.25 μm
Injection type: Split 300:1
Headspace Temperature settings: Oven 50° C., Loop 90° C., Transfer 100° C.
Headspace equilibration time: 1 min
Injection duration: 0.5 min
GC cycle time: 10 min
Vial shaking: Level 5, 71 shakes/min with acceleration of 260 cm/s²
Fill Pressure: 15 psi
GC temp program: 100° C. 2 min, 37.5° C./min to 250° C., hold 250° C. 1 min
Detector: MS (35-300 m/z), FPD (Phosphorous filter)
Solvent Delay: 3.3 min

Gelbo Flex Durability—Gelbo Flex Durability testing was performed using ASTM F392/F392M.

Headspace—Headspace GCMS was used to measure sorption capacity and decontamination ability of raw mitigants, high-free volume polymers, and mitigant layer mats. All experiments used diisopropyl fluorophosphonate (DFP) as a reactive nerve agent simulant. Test samples were loaded into 20 mL headspace vials and spiked with 1 μL of DFP. The DFP spike was applied onto a rolled-up piece of Kimwipe within the vial, rather than directly onto the specimen in order to produce a vapor challenge. After applying the DFP challenge, the headspace vials were arranged on the vial rack and loaded onto the GC. Headspace analysis run was initiated; an auto sampler was used to collect and inject 4 headspace samples from each vial in series (e.g. 5, 15, 25, 35 min timepoints). DFP adsorption was plotted against sampling time to chart DFP adsorption/breakdown by each of the samples over time. DFP adsorption is displayed total area; a 100% DFP control is included in each plot for comparison since vapor equilibrium is not achieved at early timepoints.

Laundering—Sample laundering was completed following AATCC TM135 parameters for the delicate, warm wash cycle, and screen dry/dry flat as performed on the benchtop in the absence of a programmable laboratory washer and dryer system. Briefly, aqueous detergent solution was prepared at a concentration of 0.92 g/L AATCC detergent (AATCC 1993 Standard Reference Detergent, Without Optical Brightener (WOB)A) and pre-warmed to 41° C. Sample materials were fully submerged within the detergent solution within a large beaker at a ratio of 16 in² area of sample per 1 L of detergent solution. The beaker was placed on a magnetic stir plate and a magnetic stir bar was used to agitate the mixture at 500 rpm for 8.5 min. Samples were then removed from the wash solution via tweezers and immediately transferred to a new beaker containing clean, deionized water pre-warmed to 41° C. for the rinse cycle. Sample materials were fully submerged within the rinse solution at a ratio of 16 in² area of sample per 1 L of water. The beaker containing the rinse mixture was again placed on a magnetic stir plate with a magnetic stir bar and agitated at 500 rpm for 8.5 min. The sample materials were removed from the rinse solution, laid flat on bench liner, and allowed to dry under ambient atmosphere for a minimum of 12 h.

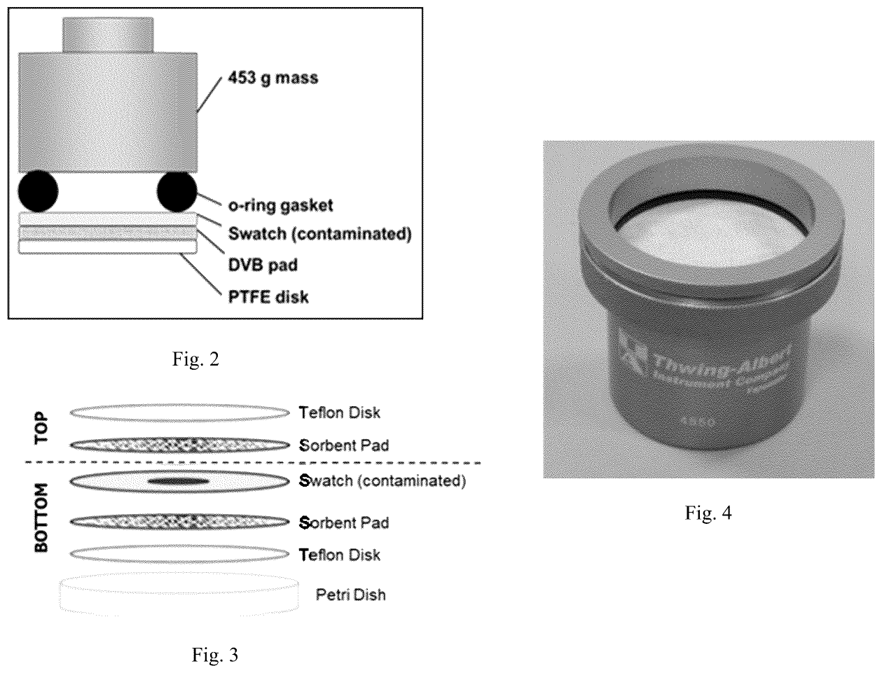

Low Volatility Agent Permeation (LVAP)—Liquid challenge/liquid penetration testing of composite samples was conducted following a method developed at ECBC based on TOP 8-2-501A expulsion testing, using a contact weight on top of the contaminated swatches. Composite swatches assembled on top of a DVB (Divinylbenzene based copolymer matrix) pad were dosed with low-volatility agent (DEVX or VX) at 10 mg/m², weight placed on top (FIG. 2), and incubated for 24 h. The DVB pad was then extracted and analyzed for agent that permeated through the sample. In some cases, composite samples were further assessed in a residual contact test. DVB pads are sorptive pads available from, for example Fisher Scientific.

Microbreakthrough—Mitigants were evaluated for total capacity and chemical retention by using a small-scale microbreakthrough system. Powders were equilibrated at the appropriate temperature and humidity prior to measurements, and approximately 5-30 mg of mitigant was loaded into a 4 mm internal diameter fritted glass tube. Liquid GB was contained within a glass saturator cell with a ceramic wick. An air stream was pushed through the cell, and the saturated vapor subsequently was mixed with a diluent stream at rates necessary to achieve a concentration of approximately 900 mg/m³. Materials were tested under dry (approximately 0% RH) conditions. The effluent stream was monitored continuously using a Fourier transform infrared detector. After saturation, the feed was terminated, and the effluent was monitored to detect desorption of the target chemical. The capacity was calculated via mass balance at saturation and after desorption. For ammonia, and chlorine, a specific amount of chemical was injected into a ballast and subsequently pressurized to yield a concentration of 5,000 mg/m³ for each of the chemicals. The ballast contents were then mixed with a diluent air stream containing the required moisture content, conditioned from a temperature-controlled saturator cell, at a rate necessary to achieve challenge concentrations between 1,000 and 4,000 mg/m³. The mixed stream then passed through a sorbent bed submerged in a temperature-controlled water bath. Approximately 55 mm³ of each sample was packed into a 4 cm length and 4 mm diameter tube and was tested as a powder under dry (0% relative humidity, RH) and humid (80% RH) conditions. Samples were pre-equilibrated at the test RH for approximately 1-2 h. The effluent stream then passed through a continuously operating Hewlett-Packard 5890 Series II gas chromatograph equipped with a photoionization detector for ammonia. Chlorine was measured using an electrochemical cell detector. Loadings were calculated in mole per kilogram by integrating the breakthrough curves at saturation. The system exhibits approximately 10% deviation with respect to saturation loading.

Nuclear Magnetic Resonance (NMR)—¹H, ¹³C, and ¹⁹F NMR spectra were recorded on a Bruker 500 MHz spectrometer. ¹H and ¹³C spectra were calibrated using residual solvent as an internal reference (CHCl₃: δ 7.26 ppm and δ 77.36 ppm, respectively). Broadband ¹H decoupling was used during the collection of ¹³C and ¹⁹F NMR spectra. The following abbreviations were used to denote multiplicities: s=singlet, bs=broad singlet, d=doublet, t=triplet, q=quartet, m=multiplet.

Particle Size Analysis (PSA)—Particle size was analyzed using a Malvern Mastersizer 3000 laser diffractometer. Raw materials were analyzed as aqueous suspensions using the Hydro MV accessory. If limited raw material was provided, samples were analyzed with the Hydro SV accessory. Dry finished composite particles were analyzed using the Aero S accessory to minimize any breakdown of the particles that could occur if dispersing into water for analysis with the MV or SV accessory. The default refractive index of 1.52 and the General Purpose analytical model were used for all measurements. Electron micrographs were collected using a Carl-Zeiss EVO-50EP environmental scanning electron microscope. Samples were prepared by adhering powder to double-sided conductive carbon tape. With no further preparation (e.g. no sputter coating), samples were imaged under partial vacuum, typically 10-100 Pa, using a backscatter detector (BSD) at 20 kV with a tungsten filament electron source. Images were collected at 100×, 250×, 500×, 1000×, 2500×, and 5000× magnification.

Repellency (Agent) (or Time Modified LVAP)—To assess the ability of coated materials to repel agents (specifically VX), 50 mm diameter swatches were placed on top of a DVB pad and dosed with 6×1 uL droplets of VX (10 g/m² challenge). A 453 g mass was placed on an O-ring on top of this assembly to effectively close each test cell and was left to incubate for a designated time (30 sec, 5 min, 30 min). Following incubation, the weight and O-ring were removed, a DVB placed on top to absorb any VX still remaining on top (as shown in FIG. 3) and weight temporarily restored for 60 sec. Test cells were then dismantled and each layer analyzed for VX content. Swatches were tested in triplicate.

Scanning Electron Microscope (SEM) Imaging—The surface morphology of the fiber/mitigant sample was analyzed using a scanning electron microscope (SEM) JEOL JSM 6390 (Tokyo, Japan) operated at 10 keV to obtain the micrographs. The fiber samples were palladium coated in a Denton Vacuum (Moorsetown, NJ, USA) Desk IV sputter coater for 180 seconds to focus, view, and image at different magnifications. The fiber diameter of samples was measured at multiple locations in the same image using ImageJ analysis.

Thermal Resistance—Thermal Resistance of material, mitigant and composite swatches were evaluated following the ASTM F1868 test method. The dry heat transfer test was performed according to ASTM F 1868-02 standard using a sweating guarded hotplate in a temperature and humidity-controlled chamber (ESPEC EPX-4H, Aurora, CO, USA). The fabric specimen is cut into a 12-inch×12-inch rectangle that covers the whole area of the hotplate. When the fabric was spread over the hotplate, a 7 mm (about 0.28 in) distance was maintained between the air flow probe and the fabric. Additionally, it was ensured that there was no air bubble/gap between the specimen and the hotplate. The chamber was set to bring the experiment into a steady state condition for 4 hours, and then the test was run for 30 minutes with a data acquisition rate of 1 data per minute. Data was recorded for the dry heat transfer in m2·° C./W. Swatches and hot plate were allowed to equilibrate at the set temperature and humidity for several hours before analyzing. Swatches were placed in the center of the hot plate and a 2.5 inch mask was placed over the sample. The conditions for the run were set at ambient temperature=25° C., plate temperature=35° C., relative humidity=65%, and windspeed=1 m/s. Each fabric was run in triplicate.

Thermogravimetric Analysis (TGA)—The weight composition of the as-spun composite membranes was verified by thermogravimetric analysis (TGA) using TA Instruments' DSC-TGA Discovery model at a ramp rate of 20° C./min. The temperature range investigated was 50° C. to 650° C. under N₂ atmosphere; or a TGA 550 from TA Instruments, where the ramp speed was 10° C. mint, and isotherms were performed from room temperature to 900° C. The degradation temperature (Td) of a polymer is the temperature at which the polymer loses 10% of its initial mass. Thermal transitions were determined by differential scanning calorimetry (DSC) using a Discovery DSC from TA Instruments with powdered samples (5-8 mg) sealed in aluminum pans.

Thickness—Method, ASTM D1777, Standard Test Method for Thickness of Textile Materials—Thickness of the materials were determined by displacement between a pressure foot and the base of the thickness gauge. Specimens were not pre-conditioned at 21+/−1° C. (70+/−2° F.) and 65+/−2% relative humidity; however, they were tested at those conditions most of the time. The specimen number varied depending on the amount of available material. Specimens were placed face side up on the base of the thickness gauge and the pressure foot was lowered and contacted the material. The thickness reading was recorded.

Water Vapor Moisture Transport Rate (MVTR)—The measurement of water vapor transmission through materials and composites was conducted according to ASTM E96: Procedure B (24 h). Water vapor transmission of materials were measured using the Water Method. The environmental test chamber was set at room temperature and 50+/−2% RH. The EZ-Cups (Thwing-Albert.com, FIG. 4) have a mechanical closure using two neoprene seals and a Teflon seal with a threaded flanged ring. Air continuously flowed across the specimens at approximately 1 ft/s. The specimen number varied depending upon the amount of available material. Circular specimens were cut to a diameter of approximately 74.6 mm (2.94 in.) and the mouth of cups was 63.5 mm (2.5 in.). Distilled water was poured into the EZ-Cups approximately 19 mm (0.75 in.) from the secured specimens. The test cups were weighed and placed upright in the test chamber. The test cups were removed periodically and re-weighed for a period of not less than 24 hours.

In SI units:
G=weight change, g
t=time, h
A=test area (cup mouth area), m² (diameter of cup mouth is 0.0635 m)
WVT=rate of water vapor transmission, g/h·m²

Weight—Weight of material and composite samples were measured according to ASTM D3776 Standard Test Methods for Mass Per Unit Area (Weight) of Fabric. Fabric weight was calculated from the mass of a specimen and the length and width were measured. Option C—Small Swatch of Fabric of ASTM D 3776 requires a minimum specimen of 100 cm² (15.5 in.²); however, smaller specimen swatches were used because of the limited amount of available material. Specimens were not pre-conditioned at 21+/−2° C. (70+/−4° F.) and 65+/−5% relative humidity; however, they were tested at those conditions most of the time. The specimen number varied depending upon the amount of available material. The length (1) and width (w) of the specimen were measured in mm (in.) and the area (A) was determined, A [mm² (in.²)]=1×w. The mass (G) of the specimen was measured on a balance. The mass per unit area was then either calculated in SI units as:

$$g / {m}^{2} = 106 G / A$$

where:
G=total mass of specimen(s), g
W=width of fabric, mm, and
A=area of specimen, mm²
And/or
oz/yd²=1296G/A where:
G=mass of specimen, oz
W=width of fabric, in., and
A=area of specimen, in.²

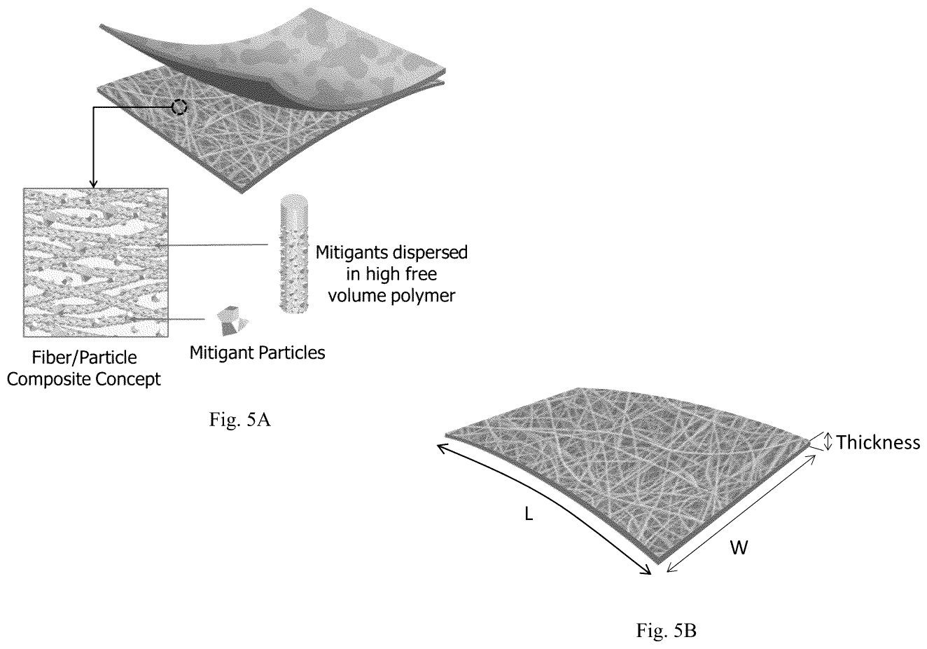

FIG. 5A is a schematic representation of a material according to various non-limiting embodiments of the present disclosure. The material includes a dense and highly porous network comprising electrospun polymeric nanofibers and mitigant particles. The mitigant particles can be dispersed directly within the polymer nanofibers and/or entangled within the dense and highly porous polymer fiber network. In various non-limiting embodiments, the mitigant particles are in the form of microparticles retained between the polymeric nanofibers. In certain non-limiting embodiments, the mitigant particles can be retained within the matrix by physical contact with the polymeric fibers. For example, the mitigant particles can be trapped within the polymeric fibers and pores of the polymeric fibers surrounding the particles can be smaller than the mitigant particles such that the mitigant particles cannot substantially pass through the pores. In various non-limiting embodiments, a polymer crosslinker and/or adhesive can be used to adhere mitigant particles to the polymeric fibers. The material can be a composite material further comprising an outer layer on top of an active layer comprising the mitigant particles, as illustrated in FIG. 5A, and a base layer or substrate directly beneath the active layer.

The polymeric nanofibers are comprised of polymeric materials. The polymeric nanofibers can be comprised of a hygroscopic and/or water-soluble polymer, such as, for example, polyvinyl alcohol (PVA) and/or polyvinyl-pyrrolidone (PVP), having an average molecular weight in a range of 20,000 g/mol to 300,000 g/mol, such as, for example, in a range of 50,000 g/mol to 100,000 g/mol. The composition of the polymeric nanofibers can be configured to facilitate a dissolution thereof in water to produce an electrospinnable solution. In various non-limiting embodiments, the polymeric nanofibers are nanofibers of 99 mol % hydrolyzed PVA having an average molecular weight (MW) of 78,000 g/mol.

Alternatively, or additionally, the network can comprise water insoluble polymeric nanofibers, such as Nylon 6. The insoluble fibers can resist degradation after exposure to rain, sweat, and/or cleaning procedures. In various non-limiting embodiments, the network can comprise water soluble polymer nanofibers.

The polymeric fibers can comprise connection points between fibers. The connection points form when polymer is deposited wet and as the polymeric fibers dry they can adhere to one another and form a matrix. Upon completion of material production, optionally a heat-curing step can be used to further stabilize the polymeric fibers against dissolution.

Now referring to FIGS. 5 and 5A, an area of the active layer and/or material is defined by an outer surface of the network which is a product of a network length L multiplied by a network width W. The network comprises a thickness extending normal to the area of the active layer. In various non-limiting embodiments, the thickness of the network spans an entire thickness of the active layer, which may be on a scale of 1 mm to 10 mm, such as, for example, 1 mm to 2 mm. An active layer can comprise the mitigant particles and inactive polymer layers can be used for support and/or filtration.

In certain non-limiting embodiments, the material may be configured to decontaminate a variety of threat agents without relying on a bulky layer and/or multiple decontamination layers bound to one another with weight increasing binders, thereby substantially enhancing a thermal and/or weight burden associated with the material. In various non-limiting embodiments, the material can comprise other layers and/or the thickness may span less than the entire thickness of the material. For example, the material can comprise an active layer, a top layer, and a backing layer, with the active layer intermediate the top layer and the backing layer. In various non-limiting embodiments, the material may only comprise an active layer.

The diameter of the mitigant particles can be configured such that they are retained within the network. For example, the mitigant particles can have a diameter greater than a pore size of the network and/or greater than a spacing between neighboring nanofibers of the network (e.g., size of the gaps within the polymeric fiber network). In various non-limiting embodiments, the mitigant particles have diameters no less than 1 microns (μm), or diameters on the order of tens of microns, such as diameters in a range of 5 μm to 40 μm. In certain non-limiting embodiments, the pore size of the network can be less than 1 μm, such as, for example, less than 500 nm, less than 100 nm, less than 50 nm, less than 10 nm, or less than 2 nm.

The mitigant particles can include metal organic framework (MOF) based microparticles configured for facilitating and/or catalyzing decontamination of a range of threat agents. The material can include an amount of MOF microparticles in a range of 1 gram (g) to 1 kg of MOF microparticles per square meter (m²) of the network based on the entire area of the network, such as, for example, 40 g to 600 g. In various non-limiting embodiments, the active layer or material can include at least 1 g, at least 5 g, at least 10 g, at least 40 g, at least 70 g, at least 80 g, at least 90 g, at least 100 g, at least 120 g, at least 200 g of MOF microparticles per m2 of the network based on the entire area of the network. In various non-limiting embodiments, the active layer can include no greater than 600 g, no greater than 500 g, no greater than 400 g, no greater than 300 g, or no greater than 250 g of MOF microparticles per m² of the network based on the entire area of the network.

The MOF microparticles can be zirconium based MOFs (e.g., Zr-MOF class), such as, for example, zirconium oxide and/or zirconium hydroxide based MOFs or other metal based MOFs, such as, for example copper based MOFs. The MOF microparticles can be based on various different ligand. For example, the MOF microparticles can be based on a Universitetet i Oslo 66 (UiO-66-NH₂) Zr-MOF having the structure shown in structure 1.

### Structure 1

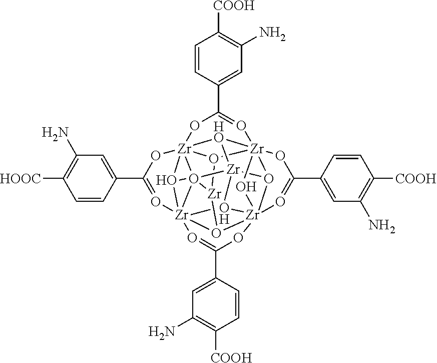

UiO66-NH₂ Zr MOF is formed from Zr₆O₄(OH)₄ clusters at the center of the complex, bridged by terephthalic acid ligands. UiO-66-NH₂ was selected by the inventors for its porosity, ultra-high surface area, functional group tunability, stability, and ability to degrade chemical warfare agents. UiO66-NH₂ can be capable of rapid decomposition of nerve agents, mustard agents and/or toxic organophosphates, neutralizing agents like GB into 0-isopropyl-methylphosphonic acid (IMPA) via hydrolysis shown in Scheme 1 below.

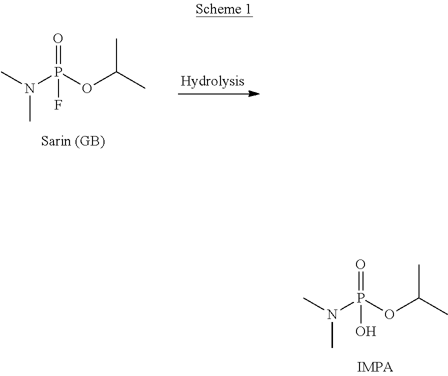

Other possible MOFs that may be incorporated into materials and/or layers according to the present disclosure include, for example, MOF-808, MOF-801, UiO-66, UiO-67, NU-901, NU-1000, NU-1400, or other materials in the Zr-MOF class.

The MOF particles can be configured to decontaminate a chemical threat agent in contact with the material and/or active layer. For example, the MOF particles can be configured to decontaminate nerve agents, such as G series and/or V-series nerve agents, and/or blister agents, such as mustard gas/HD. In various non-limiting embodiments, the MOF particles can comprise microparticles configured to decontaminate a variety of threat agents including DEVX, 2-CEPS, VX, HD, GD, GB, simulants thereof, or any combination thereof. For example, the active layer and/or material can comprise UiO-66-NH₂ Zr-MOF microparticles having an outer diameter in a range of 300 nm to 2000 μm, such as, for example, 10 μm to 30 μm or about 10 μm, a surface area in a range of 100 to 1000 m²/g, such as, for example, 603 m²/g, and a pore size in a range of 1 Å to 50 Å, such as, for example, 20.4 Å.

The 10 μm UiO66-NH₂ showed very good function in the variety of simulant, live agent, and TIC degradation testing conducted. UiO66-NH₂ degraded 94% and 96% of a 10 g/m² challenge of GD and VX respectively. UiO66-NH₂ also showed increased capacity to absorb GB, ammonia (NH₃), and chlorine (Cl₂) challenges as compared to carbon beads. These results are shown in Table 1 below.

TABLE 1
Gas and liquid chemical absorption capacity testing of UiO-66-
NH₂ vs. carbon-based mitigants currently used in the SOA (dermal)

| | | | | Gas | |
|---|---|---|---|---|---|
| | Evaluation | Threat | Percent | Capacity | Replicate |
| Mitigant | Method | Challenge | Reacted | (mol/kg) | number |
| UiO-66-NH₂ | Dose Extraction | GD | 94% ± 4% | — | n = 2 |
| | | VX | 96% | — | n = 1 |
| | | DEVX | 86% | — | n = 3 |
| Carbon Beads | Dose Extraction | GD | 21% ± 1% | — | n = 2 |
| | | VX | 47% | — | n = 1 |
| | | DEVX | 36% ± 3% | — | n = 3 |
| UiO-66-NH₂ | Microbreakthrough | GB | — | 5.5 ± 0.1 | n = 2 |
| | | NH₃ | — | 2.2 | n = 1 |
| | | Cl₂ | — | 1.9 | n = 1 |
| Carbon Beads | Microbreakthrough | GB | — | 2.7 | n = 2 |
| | | NH₃ | — | 0.3 | n = 1 |
| | | Cl₂ | — | 1.0 | n = 1 |

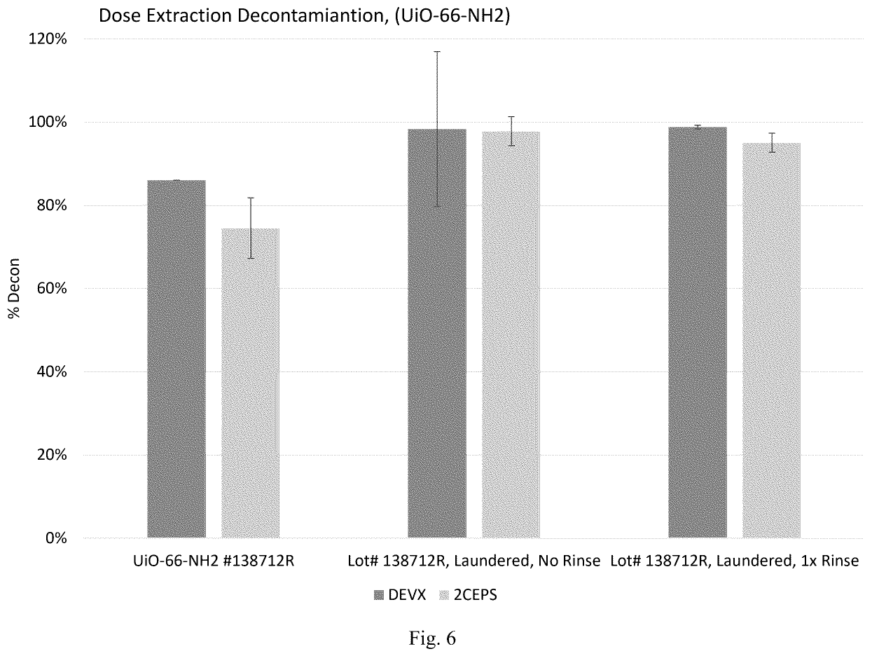

To analyze the durability of the UiO-66-NH₂ suitability for the intended applications, the reactivity of the UiO-66-NH₂ 10 μm powder was measured pre- and post-laundering. An altered laundering protocol was utilized in this test, using 0.1% All Free and Clear laundry detergent in a 6-minute wash cycle instead of the standard 0.92 g/L AATCC powdered detergent in an 8.5-minute wash cycle. FIG. 6 shows the maintained integrity of the powder as quantified by D/E post-laundering. The UiO-66-NH₂ 10 μm powder was also washed, without a rinse cycle, to verify if the mitigant reactivity would not be decreased in the event that the detergent was not fully rinsed out. Ultimately, neither the laundering nor the lack of a rinse cycle were detrimental to the decontamination capacity of the UiO-66-NH₂ powder, and all laundered conditions achieved nearly full decontamination of the 10 g/m² DEVX challenge

Now referring back to FIG. 5A, the polymeric nanofibers and the MOF microparticles can be present in a weight ratio of polymeric nanofibers to MOF nanoparticles in a range of 1:1 to 1:6, such as, for example, 1:1 to 1:5, 1:1 to 1:4, 1:2 to 1:6, 1:2 to 1:5, 1:3 to 1:5, 1:2 to 1:5, 1:2 to 1:4, or 1:3 to 1:4. In various non-limiting embodiments, the active layer is configured to maximize the amount of MOF loaded into the active layer without dusting or losing microparticles from the inner or outer surface of the active layer.

The material according to the present disclosure can be configured to have a filtration efficiency no lower than 99%, no lower than 70%, no lower than 50%, or no lower than 30%, against particles having an average diameter of 300 nm determined according to NIOSH standard.

The material can be configured to provide an average total gas permeation no greater than 10 micrograms for the chemical threat agent per cm² of material based on the area of the material as determined according to TOP 8-2-501A.

The material can be configured to provide a Low Volatility Agent Permeation (LVAP) no greater than 1 microgram per cm² of material for a nerve agent as determined according to TOP 8-2-501A, wherein the LVAP is based on a 10 milligram/m² dosage of the nerve agent.

In some aspects, the material can be configured to provide enhanced comfort to an operator. For example, the thickness and/or composition of the network and/or the weight ratio of polymeric nanofiber to mitigant particles can be configured to provide a thermal resistance of 0.1° C.-m²/W or less according to ASTM F 1868-02, or in some examples, a thermal resistance no greater than 0.04° C.-m²/W.

The material can be configured to provide a water vapor moisture transport rate of 600 g/m²/day or greater, for example 1000 g/m²/day or greater, according to ASTM E96 Procedure B (24 h). The water vapor moisture transport rate may be 10,000 g/m²/day or less according to ASTM E96 Procedure B (24 h). As discussed in further detail elsewhere in the present disclosure, these low burden configurations are capable of providing adequate protection properties to maintain the safety of an end user without unduly limiting their ability to move or perform duties in environments where they may be unpredictably exposed to a variety of CB agents. The water vapor moisture transport rate can be enhanced by the porous of the polymeric fibers.

The material can be configured to have a weight no greater than, for example, 25 ounces per square yard of material (oz/yd²), no greater than 20 oz/yd², no greater than 18 oz/yd², no greater than 15 oz/yd², no greater than 14 oz/yd², no greater than 9 oz/yd², no greater than 8 oz/yd², no greater than 6 oz/yd², no greater than 5 oz/yd², no greater than 4 oz/yd², no greater than 4 oz/yd², or no greater than 3 oz/yd² determined according to ASTM D3776 Option C. The material can be configured to have a weight of at least 0.5 oz/yd², such as, for example, at least 1 oz/yd² determined according to ASTM D3776 Option C. The weight can be tuned based on the polymeric network configuration, the weight ratio of polymeric nanofibers to MOF nanoparticles, types of MOFs, and/or manufacturing processes.

In various non-limiting examples where the material comprises a base layer, the base layer has a weight no greater than 1.5 oz/yd², such as a weight of 0.8 oz/yd².

In examples where the material is configured to have a weight no greater than 18 oz/yd², the material can maintain a suitable decontamination efficacy. For example, the active layer can be configured to decontaminate at least 70% by weight of a chemical threat agent as determined with a dose extraction method against a 10 g/m² challenge of the chemical threat agent, such as, for example, at least 80% by weight, or at least 90% by weight. The decontamination percent can be based on GC/MS analysis.

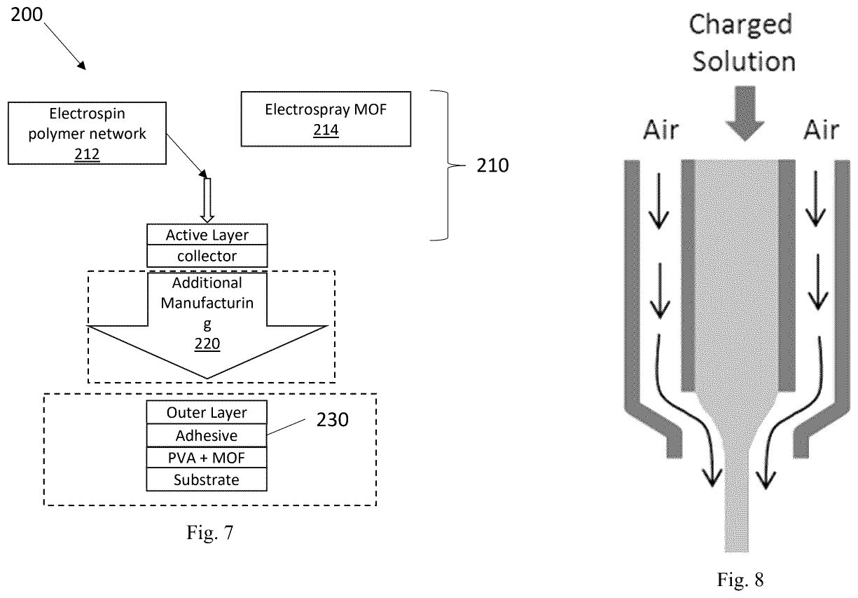

FIG. 7 is a flow diagram of a method 200 for producing a material according to the present disclosure, the method comprising depositing 210 the material onto a collector. The material of the method is similar in many respects to the material disclosed hereinabove. Thus, the material can be configured to decontaminate a chemical threat agent in contact with the material (e.g., direct physical contact). For example, the material can wick the chemical threat agent such that the chemical threat agent can enter the material and contact with the mitigant particles. In various non-limiting embodiments, at least a portion of the wicking can be facilitated by the high surface area of both the polymeric fibers and the MOF and/or compatibility of the polymeric fibers and the MOF with the chemical threat agent.

The method 200 can optionally include additional manufacturing steps 220 and/or forming 230 an outer layer on the deposited active layer. The additional manufacturing steps 220 may include laundering, thermally curing, and/or chemically crosslinking the deposited active layer, such as, for example, thermally curing the deposited active layer for at least 1 hour at 140° C.

The forming 230 an outer layer may further comprise adhering an outer layer onto the active layer. Although the additional manufacturing 220 and forming 230 are illustrated as serial operations, these operations may also occur simultaneous or in different orders, such as performing the additional manufacturing steps on a composite of an outer layer adhered to an active layer.

Depositing 210 the active layer can comprise electrospinning 212 a first mixture onto the collector and electrospraying 214 a second mixture onto the collector serially and/or concurrently with electrospinning 212 the first mixture. In various non-limiting embodiments, electrospinning 212 and 214 occurs at least partially concurrently.

The first mixture comprises a polymeric material, such as a hygroscopic polymer, dissolved in a solvent. In various non-limiting embodiments, the polymeric material is a hygroscopic material such as PVA, nylon-6, or PVP (polyvinylpyridine). For example, the first mixture can comprise 99 mol % hydrolyzed PVA. The PVA can comprise a MW in a range of 20,000 g/mol to 300,000 g/mol. The PVA can be dissolved in water (e.g., deionized (DI) water, RO water) at a concentration in a range of 10% by weight to 15% by weight based on the entire weight of the first mixture. The concentration may be adjusted based on solubility of the polymer in water. In some examples, the first mixture comprises 12% by weight of 99 mol % hydrolyzed PVA having a MW of 78,000 g/mol dissolved in DI water. The first mixture can further comprise a small amount of a surfactant based on the volume of the first mixture, such as 1 drop of Triton X-100 for every 10 mL of first mixture.

The method 200 can further comprise preparing the first mixture wherein a temperature of the combined polymeric material and solvent is elevated for a duration of time. For example a temperature in a range of 90° C. to 99° C. and a time period of at least 18 hours for mixtures based on PVA and DI water may be used. The time and temperature can be adjusted as desired for a particular application.

The second mixture can comprise a suspension of mitigant particles in a carrier fluid. For example, the second mixture can comprise MOF microparticles and a water miscible solvent. For example, the second mixture can comprise 1% by weight to 5% by weight of MOF microparticles, or 3% by weight MOF microparticles, based on the total weight of the second mixture. The water miscible solvent can comprise isopropyl alcohol or other solvent type. The MOF microparticles can comprise UiO-66-NH₂.

The first mixture and the second mixture can be charged mixtures. For example, the mixtures may be dispensed or pumped as charged mixtures from independent conductive needles held at a high voltage with respect to a grounded collector.

Electrospinning 212 the first mixture can comprise pumping the first stream at a flowrate in a range of, for example, 1 mL/hour to 5 mL/hour, such as, for example, 2 mL/hour.

Electrospraying 214 the second mixture can comprise pumping the second stream at a flowrate in a range of, for example, 10 mL/hour to 40 mL/hour, such as, for example, 30 mL/hour.

The method 200 can comprise pumping multiple first streams, each at a flowrate in a range of, for example, 1 mL/hour to 5 mL/hour, and multiple second streams, each at a flowrate in a range of, for example, 10 mL/hour to 40 mL/hour. Each of the needles may independently be configured to have diameters corresponding to a range of, for example, 24 gauge (ga) to 16 ga.

The electrospinning 212 and/or the electrospraying 214 can be air-assisted. For example, FIG. 8 shows an air assisted process where a mixture being ejected as a charged stream from a needle is combined with an air stream. The charged stream exiting the needle can be coaxially positioned within the first air stream.

An air assisted electrospinning 212 can be performed with an air pressure in a range of, for example, 3 psig to 7 psig. An air assisted electrospraying 214 can be performed with an air pressure in a range of, for example, 12 psig to 20 psig.

The collector can be a drum rotating at a rate in a range of, for example, 1 rpm to 20 rpm. The drum may also be set to traverse a width defined as a transverse distance separating the two outermost needles used for electrospinning 212 and/or electrospraying 214.

The material can be deposited directly onto the drum as a free-standing layer or, in some cases, may be deposited onto a substrate configured as a base layer affixed to the drum. For example, the active layer may be sprayed onto a nonwoven or woven Nomex fabric having a weight in a range of 0.8 oz/yd² to 1.5 oz/yd².

Performing the method 200 according to the parameters disclosed hereinabove can provide an active layer having a MOF microparticle mitigant loading level of at least 50 g/m².

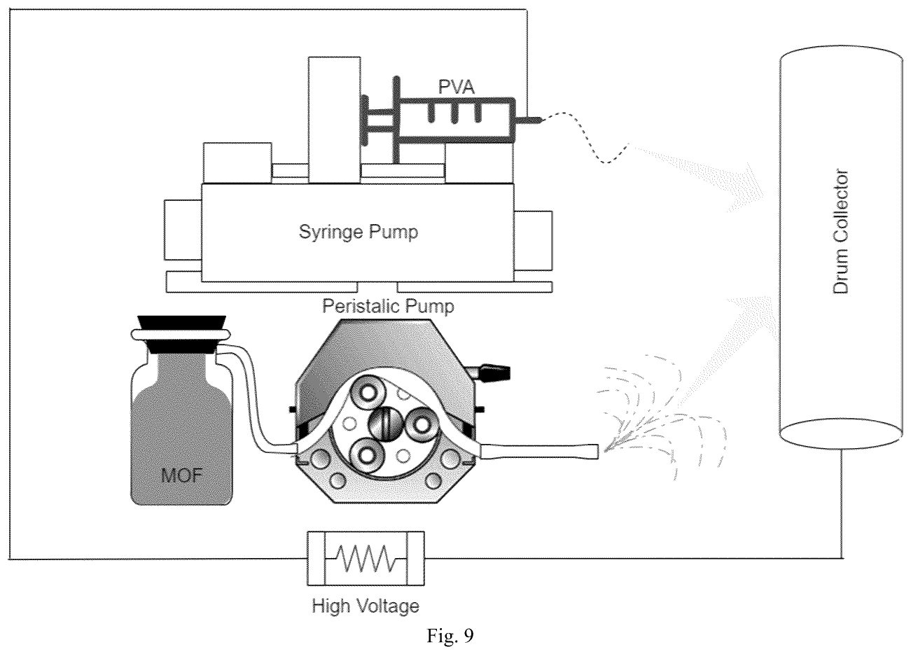

FIG. 9 is a schematic representation of a co-electrospin-electrospray system which can be used in a method for producing materials of the present disclosure, such as the method 200 disclosed hereinabove. The co-electrospin-electrospray system comprises a first pump for electrospinning a first mixture, such as a solution comprising PVA, and a second pump for electrospraying a second mixture, such as a suspension of MOF microparticles. The first pump can be, for example, a syringe pump and the second pump can be, for example, a peristaltic pump.

### EXAMPLES

The present disclosure will be more fully understood by reference to the following examples, which provide illustrative non-limiting aspects of the present disclosure. It is understood that the present disclosure is not necessarily limited to the examples described in this section.

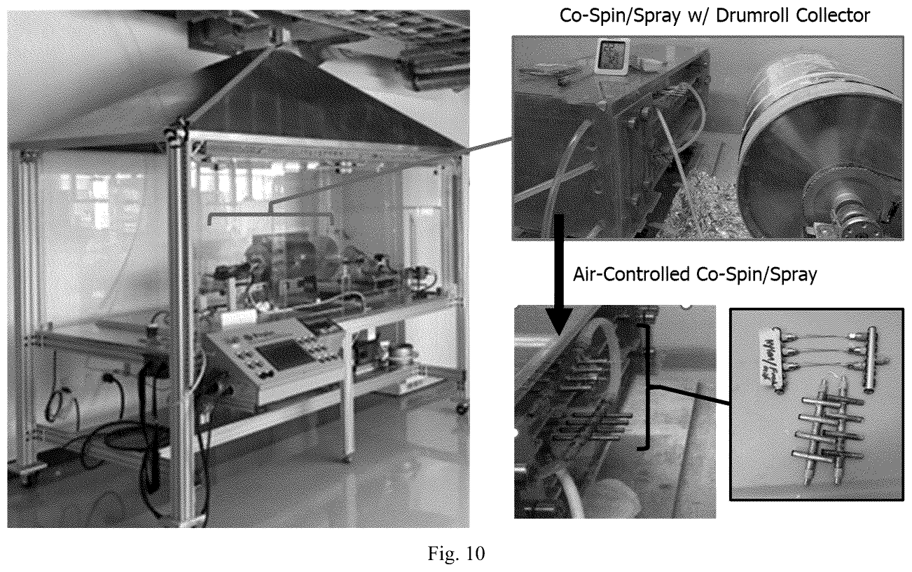

FIG. 10 shows an example of the co-electrospin-electrospray system of FIG. 9. A custom-built apparatus was employed to enable simultaneous electrospinning and electrospraying of at least two different formulations. Acrylic stacks (FIG. 10, right top and bottom) were built to accommodate multiple needle arrays to facilitate simultaneous deposition of the electrospun and electrosprayed solution in layer-by-layer fashion. Acrylic was used for the stacks to ensure each needle array was insulated from those beside it to prevent stream arcing. The set up also enabled tuning to adjust the distance between the needle and the collector. Each spinneret was connected via designated tubing and syringe pump to constantly feed formulation solution to the needle array while electrically insulating the syringe pump from the spinnerets. Each needle stack was enveloped with manifolds to enable co-axial gas flow (FIG. 10, bottom) for both electrospinning and electrospraying. Co-axial air-controlled infusion was used to achieve i) high productivity of the e-spraying method (typically an order of magnitude higher per nozzle as compared to electrospinning methods that are not gas controlled), and ii) uniformity of particle dispersion with electrospraying. A drum roller (12 inch diameter, 18 inch width) was utilized for sample collection, which produced samples approximately 11 inches in width and 37.7 inches in length. The drum roller speed was adjustable from 1 rpm to 20 rpm. The majority of experiments for this work were run with the drum roller speed set to 1 rpm. The drum roller also had traverse control to ensure more even and widespread deposition of fiber/mitigants along the substrate width.

### Examples of Active Layers Comprising Nylon Nanofibers

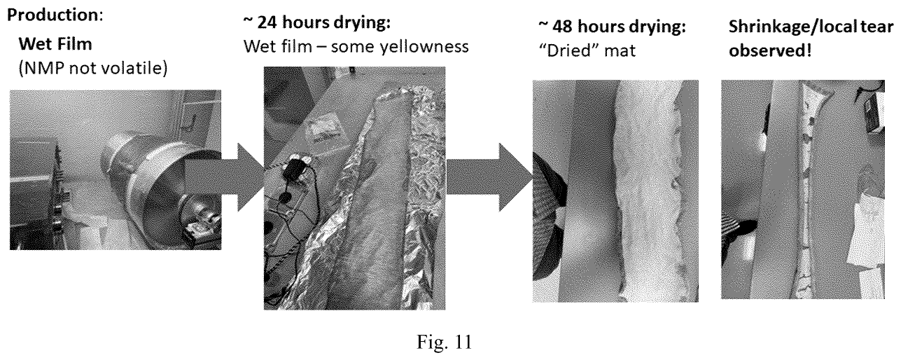

FIGS. 11-14 show results of using the co-electrospin-electrospray system of FIG. 10 described above for a layer-by-layer co-deposition of electrosprayed UiO-66-NH₂ microparticles and electrospun Nylon-6 nanofibers. In addition, the UiO-66-NH₂ powder on hand was comprised of particles with a diameter of approximately 10 μm which was compatible with the spinneret set up as well as an ideal size for capture within the resulting electrospun fiber network. Formulations for both polymer electrospinning and UiO-66-NH₂ electrospraying were designed with dual component compatibility in mind. The formulation solvent used for UiO-66-NH₂ was selected to make a stable dispersion but could not be a solvent that dissolved nylon—otherwise the nylon fibers would deform or dissolve upon UiO-66-NH₂ deposition. Likewise, the solvent used for deposition of the nylon fibers had to dissolve the nylon polymer but could not deactivate the UiO-66-NH₂ catalyst. Ultimately, formulations with nylon in formic acid and UiO-66-NH₂ in N-methyl-2-pyrrolidone (NMP) were observed to be workable co-spin/spray conditions.

Now referring to FIG. 11, initial trials of the nylon/UiO-66-NH₂ co-spin/spray composites were completed without the use of air control assist. In the absence of the air control, an extremely damp “film”-like material was deposited on to the support material, presumably due to the non-volatile nature of NMP. Because of this, extensive drying (approximately 48 hours) was necessary to yield a solid co-spin/spray mat. The dimensions of the co-spin/spray mat shrank significantly during this drying process and the composition became brittle. The co-spin/spray portion of the dried composite was such that the material pulled away from the support and localized tears were observed as depicted in FIG. 11.

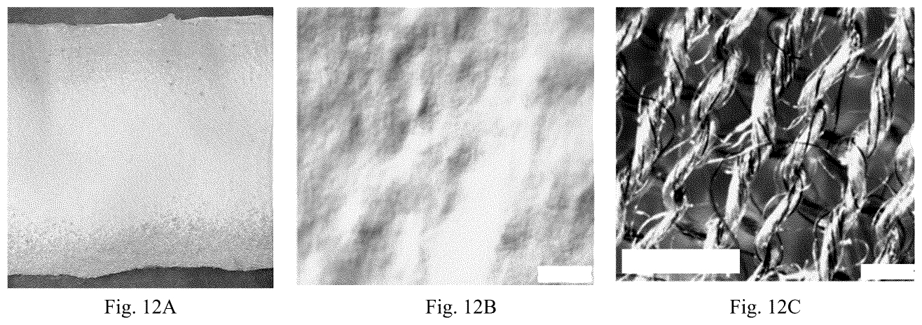

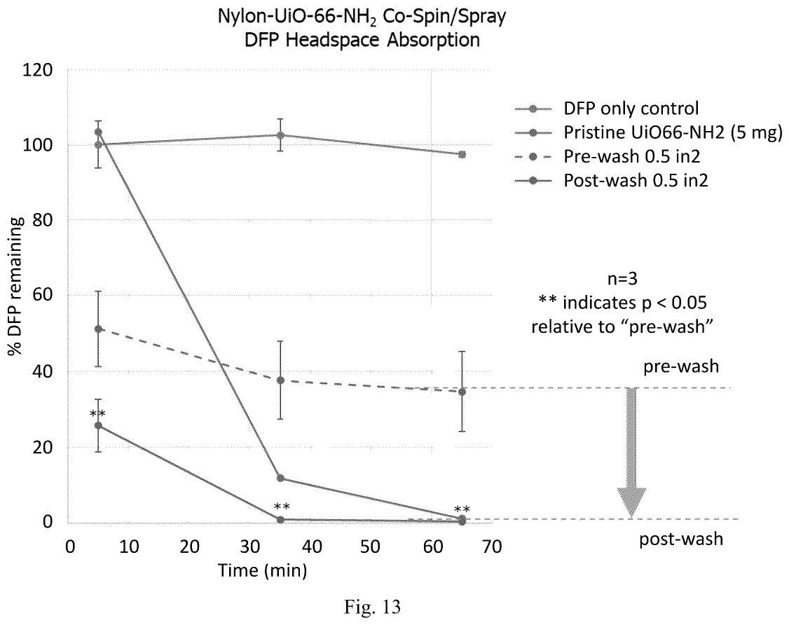

Now referring to FIGS. 12 and 13, the next trials of the nylon/formic acid and UiO-66-NH₂/NMP formulations were conducted using the air control assist feature. The inclusion of the air control enabled faster drying of the solvent from the formulations during the co-spin/spray deposition. As a result, the post-manufacture drying time required by the material was significantly decreased (<8 hours) and a marked increase in the morphology and stability of the nylon/UiO-66-NH₂ mat was observed. Using air-controlled co-spin/spray, a MOF loading of 26 g/m² was achieved as shown in FIGS. 12A-C. These samples were tested for MOF function in gas absorptivity and liquid chemical decontamination. The as-manufactured material exhibited lower gas absorption than anticipated (FIG. 13, dashed red line) and no liquid simulant decontamination in D/E experiments. Based on these results, it was hypothesized that the UiO-66-NH₂ within the co-spray/spun material may be clogged with residual solvent or polymer which was preventing proper function. The co-spin/spray mat was then “washed” via full submersion in DI water at room temperature for 5 minutes to remove any excess solvent. The material was then removed from the water bath, laid flat on the bench and air dried under ambient conditions overnight. This washing step did work to increase the DFP gas absorption of the co-spin/spray composite to acceptable levels (FIG. 13, solid red line) but these materials still had limited reactivity toward liquid agent decomposition.

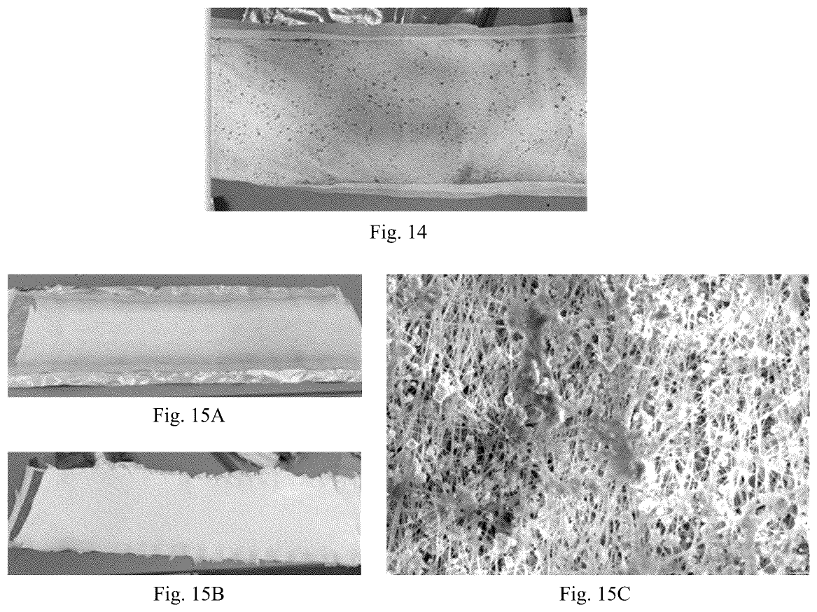

Now referring to FIG. 14, based on the functional results disclosed above, the next steps undertaken were to increase the loading of UiO-66-NH₂ within the co-spin/spray composite and to eliminate the use of NMP as the UiO-66-NH₂ co-solvent. A solvent compatibility study was conducted to identify alternative co-solvents for the UiO-66-NH₂ formulation. Isopropyl alcohol (IPA) was ultimately identified as an acceptable alternative co-solvent as it produced a stable dispersion of the UiO-66-NH₂ and was compatible with the electrospraying process. Processing and sample handling were considerably easier with the IPA formulation as compared to the NMP formulation. The manufacturing rate of the co-spin/spray composite was enhanced as well, and the IPA enabled 3-4 times the previous production rate when using NMP. Using the new formulation combination of nylon/formic acid and UiO-66-NH₂/IPA, thick mats of co-spin/spray material were targeted in an attempt to increase the mitigant loading with this core layer solution. In these runs some spots of inhomogeneity were observed where excess nylon solution was sprayed in chunks (see FIG. 14), and the dried material still exhibited some shrinking and cracking.

### Examples of Active Layers Comprising PVA Nanofibers

Examples of PVA/water and UiO-66-NH₂/IPA formulations were co-spin/sprayed on Nomex knit support. For the electrospinning, PVA/water solutions of 12 wt % were fed simultaneously with UiO-66-NH₂/IPA solutions of 2-3 wt. % for electrospraying. These solutions were all fed and processed using the co-electrospin/electrospray apparatus shown in FIG. 10 with air flow control. The flow rate between PVA and Ui-O66-NH₂ solutions were varied to change the relative composition of polymer:mitigant (ranging from 1:1 to 1:4). These co-spin/spray conditions were successful and were sufficient to produce co-mitigant mats with high catalyst content.

Composite morphology was stable at mitigant loadings approaching 80% UiO-66-NH₂ and only 20% PVA. These samples also represented a remarkable increase in the quantity of MOF loaded within the sample. Previous samples manufactured from nylon/UiO-66-NH₂ compositions achieved UiO-66-NH₂ loadings of approximately 30 g/m² at mitigant:polymer ratios of approximately 1:1, however these samples were highly inhomogeneous and brittle. By comparison, the PVA/UiO-66-NH₂ compositions achieved >80 g/m² UiO-66-NH₂ loadings and at a higher ratio of mitigant:polymer, thereby simultaneously increasing mitigant function and decreasing the burden of inactive support polymer.

Production of these co-spin/spray mats was evaluated with and without traverse of the drumroll collector. The use of traverse control of the collector during the co-spin/spray run significantly enhanced the appearance and homogeneity of the resulting composite material. For the sample collected without traverse control, a gradient of fiber and particle deposition was observed with the majority of mass collected at the center of the swatch which tapered off significantly towards the edges of the collection area (FIG. 15A). The sample collected with traverse covered the collection surface more completely and appeared to have greater integration between the fibers and particles as a stable layer (FIG. 15B, sample name MIK19). From SEM imaging of the co-spin spray composites the high UiO-66-NH₂ particle content was visibly encased within the fibrous PVA web (FIG. 15C).

The traverse sample from this production run and a second sample reproduced from the same manufacturing conditions, designated MK19 and MK 20, respectively, were taken forward into functional testing for composite MOF function in gas absorptivity and liquid chemical decontamination. The weight of these CB mitigant layers and the respective UiO-66-NH₂ mitigant loadings are listed in Table 2 below. Mitigant loadings were quantified by thermogravimetric (TGA) analysis of the composite samples.

TABLE 2
MK19 and MK20

| Mitigant | | Mitigant |
|---|---|---|
| Layer | Weight | Loading |
| Sample ID | (oz/yd²) | (g/m²) |
| MK19 | 3.14 | 86 |
| MK20 | 2.69 | 73 |
| SOA Liner | 9.62 | 210 |

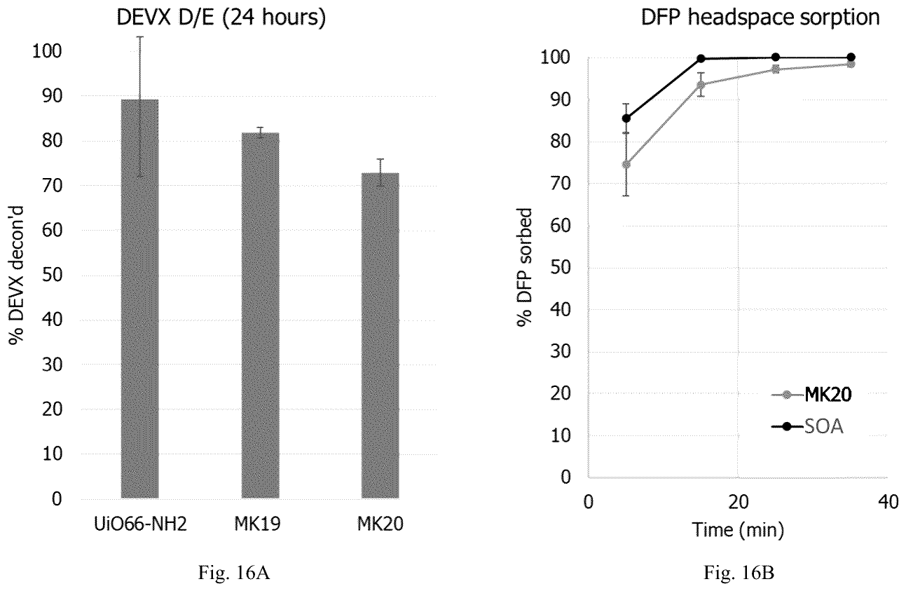

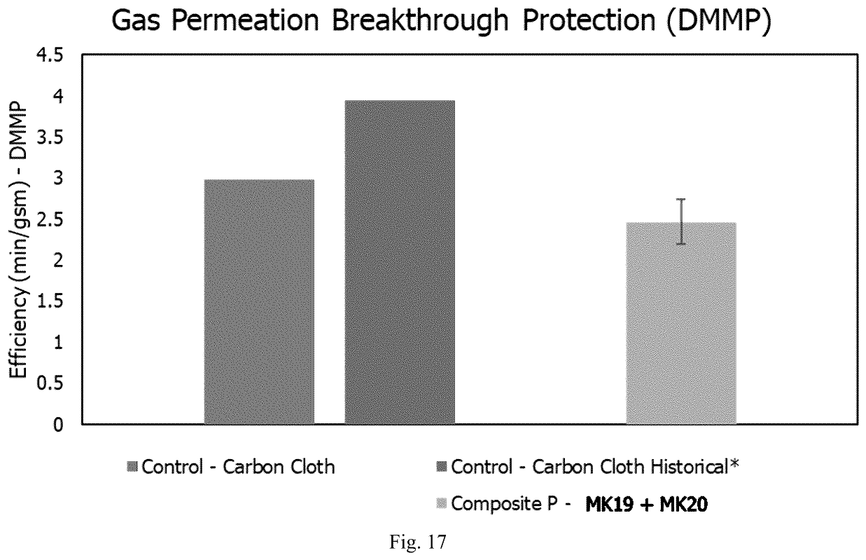

The liquid chemical decontamination function of the co-spray/spun PVA/UiO-66-NH₂ composite mats was evaluated via D/E against a 10 g/m² challenge of DEVX simulant. Both MK19 (˜80% DEVX decontamination) and MK20 (˜73% DEVX decontamination) composites achieved high levels of decontamination against the challenge within 24 hours (FIG. 16A). The gas-phase chemical absorptivity of the co-spray/spun PVA/UiO-66-NH₂ composite mat was evaluated in comparison against the state-of-the-art liner. The sample area was normalized at 0.5 in² for each material challenged against 1 μL of DFP in a 20 mL headspace vial. Loss of DFP from the headspace was observed as the gas was absorbed into the protective materials. This gas absorption from the vial headspace was tracked via timed headspace sampling. This study showed that sample MK20, which contained only 73 g/m² UiO-66-NH₂ (as compared to the 210 g/m² of carbon in SOA) displayed gas sorption performance approaching that of the state-of-the-art (FIG. 16B). Finally, gas permeation breakthrough protection testing was conducted against a gas-phase challenge of dimethyl methylphosphonate (DMMP), a non-reactive physical simulant for nerve agents (FIG. 17). For this test swatches of MK19 and MK20 were layered to form Composite P which had a total UiO-66-NH₂ mitigant loading of approximately 150 g/m². Composite P was evaluated to quantitate the efficiency of DMMP gas sorption which was measured in minutes of protection per g/m² of mitigant. This being a measure of efficiency rather than direct protection gave significant information on composite mitigant capacity to guide the mitigant loading targets which would be required to afford passing performance in critical composite functional tests such as LVAP and AVLAG later in the effort. In this testing, Composite P performed similarly to the aged “Control—Carbon Cloth,” and from this information it was extrapolated the UiO-66-NH₂ mitigant load within a co-spin/spray composite would need to be roughly equal to that of carbon currently in SOA (210 g/m²) to afford protection. While the integrated UiO-66-NH₂ was not observed to be more efficient, the co-spin/spray material has other efficiencies relevant to CB protection and PPE burden that are lacking in SOA. Namely the co-spin/spray composite is significantly lighter than the SOA liner as it contains fewer support materials. Most importantly, the co-spin/spray composite functions to actively decontaminate the CB challenges absorbed which is a significant improvement over current PPE.

### Dusting

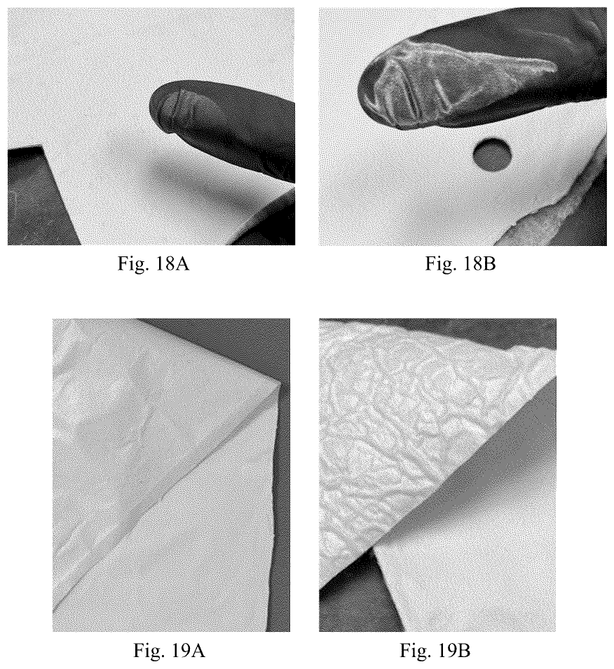

Production of a stable mitigant composite was key for inclusion of the material within the material of the present disclosure. It was found that the PVA:UiO-66-NH₂ ratio was important in determining this stability. A minimum of 20% polymer, paired with 80% mitigant formed acceptable co-spin/spray mats with a stable composition with minimal loss or “dusting” of the UiO-66-NH₂ from the surface of the material (FIG. 18A). These durable samples also maintained stable UiO-66-NH₂ mitigant incorporation entangled within the polymer web when the samples were cut across the deposition direction of the mat. Reduction of the polymer content of the PVA:UiO-66-NH₂ co-spin/spray composite beyond the 20:80 ratio, however, resulted in unstable incorporation of the mitigant where simple mechanical manipulation of the composite mat such as rubbing or twisting caused release of the UiO-66-NH₂ mitigant as a powder from the surface and sides of the sample (FIG. 18B). Decreasing the polymer:mitigant ratio further may additionally enhance the mechanical stability of the composite, but at the expense of lower breathability and reduction of the efficiency in CB protection performance. These features demonstrated the impact of the balance of the co-spin/spray material where high mitigant loading was targeted to achieve highly functional materials. This function should be within the limits of the mechanical stability of the composite and the targeted application.

### Wrinkling

Deformation of co-spin/spray mat or support substrate has an impact on both the stability of the composite mat and the overall thermal burden of the material. It was found that the most common form of co-spin/spray sample deformation was wrinkling of the support substrate which appeared to occur after the co-spin/spray deposition was complete during the drying phase. Initially, processing conditions were changed to reduce this effect, but it was ultimately concluded that the wrinkling was primarily dependent on the substrate weight and construction (nonwoven vs. woven). Nonwoven fabrics inherently provide more surface area for fiber deposition as compared to knit fabrics. While this was desirable for improved adhesion between the substrate and the membrane, the loading required to provide sufficient CB protection required that the mass of the co-spin/spray layer be significantly higher than the mass of the substrate layer. It was ultimately found that ultralightweight substrate layers, which were desirable from a burden reduction standpoint, were not compatible with the thick co-spin/spray mitigant core layers. As such, it was determined that at least two solutions were available to eliminate substrate wrinkling: either manufacture the co-spin/spray mat as a free-standing layer without support (or with releasable support) or manufacture the co-spin/spray mat on a support containing sufficient composition to support the weight and thickness of the mitigant layer. This was demonstrated in two production runs of PVA/UiO-66-NH₂ (20:80 polymer:mitigant, MOF loading approximately 80 g/m²). Co-spin/spray deposition on a heavier Nomex nonwoven (1.5 oz/yd²) provided an excellent, wrinkle-free morphology (FIG. 19A), whereas deposition on a more lightweight Nomex nonwoven (0.8 oz/yd²) resulted in severe wrinkling of the substrate support layer upon drying (FIG. 19B). Nomex knit (1.5 oz/yd²) was also found an acceptable substrate to produce co-spin/spray mats with no substrate deformation.

### Layering

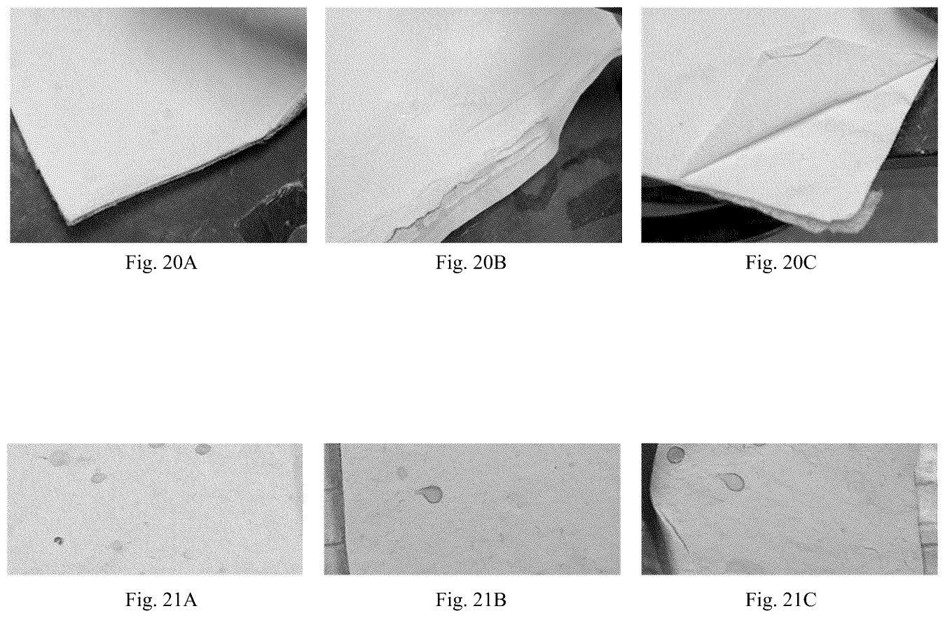

In some instances of the PVA/UiO-66-NH₂ co-spin/spray production the resulting material was not a single homogenous mat but rather exhibited “layering” where the sample appeared to be comprised of a stack of individual, thinner co-spin/spray mats (FIG. 20A, single layer mat morphology, FIGS. 20B and 20C, multi-layer mat morphology). This morphology was undesired as the layered composite showed reduced mechanical integrity as compared to the materials containing a single layer of composite. An effort was made to minimize layering within the co-spin/spray mat through evaluation of air flow control, manufacturing temperature, solvent choice, solution deposition rate and manufacturing run time. Within the scope of this project, optimization to a free-standing, wrinkle-free, dust-free, single-layered co-spin/spray mat was achieved for samples produced up to approximately 90 g/m² of MOF if the ratio of PVA:MOF was kept at 1:4, as shown in FIG. 20A. In certain embodiments, significantly higher MOF levels, for example greater than 100 g/m², greater than 120 g/m², or greater than 190 g/m² have been achieved.

### Laundering Stability

The PVA/UiO-66-NH₂ mats produced via co-spin/spray manufacturing showed excellent CB protective function; however, further manipulation was needed to make these materials suitable for use as a core layer material since the as-spun mats disintegrated when laundered or exposed to water. Two approaches were taken to stabilize the co-spin/spray mats for water exposure: thermal curing and chemical crosslinking.

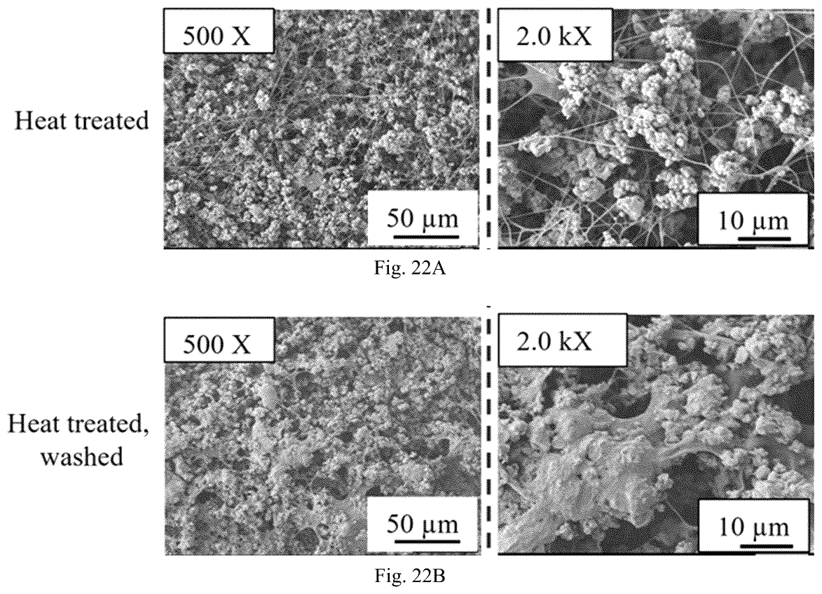

Thermal curing of the PVA/UiO-66-NH₂ was found to be a simple method of material stabilization. Heat treatments as short at 1 hour at 140° C. were sufficient to stabilize the PVA/UiO-66-NH₂ mats against macroscopic disintegration and allow them to withstand standard laundering conditions (FIG. 21). SEM images of the PVA/UiO-66-NH₂ fiber/particle mats were acquired pre- and post-laundering to characterize the impact of thermal curing and laundering on fiber morphology. Images of the heat-treated mats pre-wash showed fibrous morphologies as expected with high entanglement of fibers around the aggregated MOF particles (FIG. 22A). Yet, the images of the heat-treated mats post-wash were surprising. While macroscopically these samples appeared to maintain their composition post-laundering, microscopically SEM imaging revealed that the fibers previously observed largely collapse into a membrane-type morphology upon laundering with air drying (FIG. 22B). It was found from additional studies of the thermal cure conditions that additional fiber stability could be gained by extending the duration of the curing step (up to 4 days was studied). In addition, some of the fiber instability post laundering was found to be a function of both the duration and temperature of the sample exposure to water. Fiber morphology could be preserved through 6 launderings if a forced drying step (1 hour in the oven at 100° C.) was implemented instead of allowing the samples to air dry at ambient conditions overnight.

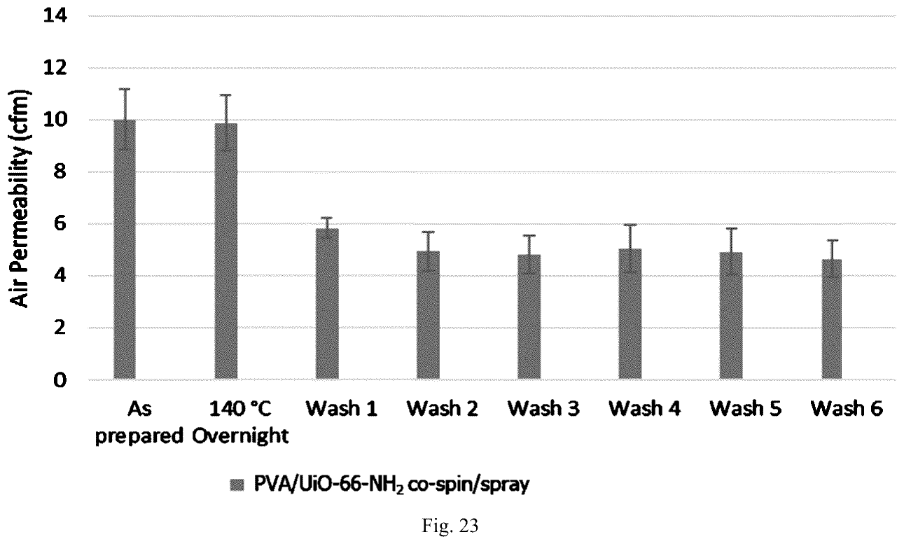

Since changes in the fiber morphology were observed upon laundering, sample air permeability was evaluated as a function of thermal treatment and exposure to wash conditions. Air permeability was measured from a set of triplicate samples in between each conditional manipulation as it was thermally cured and subsequently laundered through 6 laundering cycles (FIG. 23). The electrospun mats were thermally cured at 140° C. for 16 hours prior to initiating laundering. This thermal treatment did not appear to significantly affect the air permeability of the material. Upon the first laundering the air permeability appeared to decrease by 40% but this stabilized after the first laundering and significant additional loss in air permeability was not observed for laundering cycles 2-6.

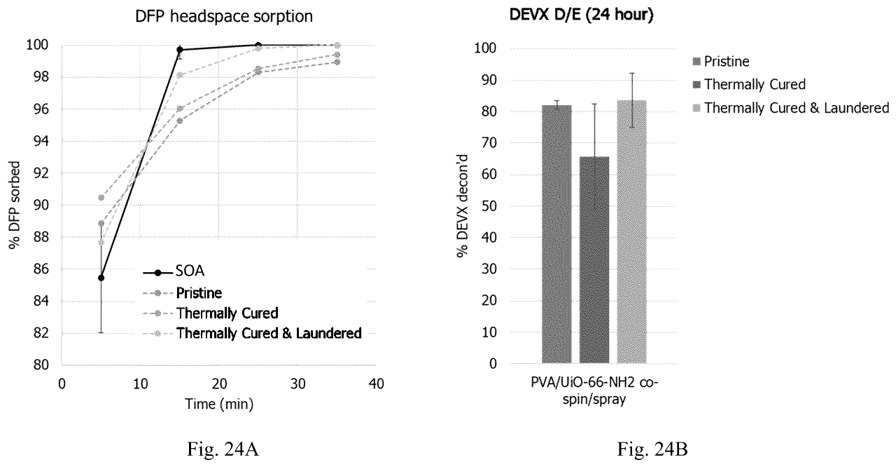

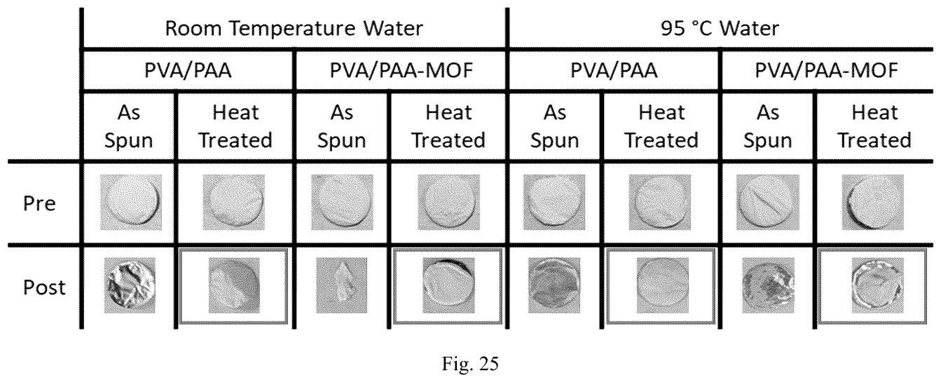

Regardless of the microscopic fiber morphology, the thermally cured PVA/UiO-66-NH₂ mats maintained their CB protective function, in addition to macroscopic shape, post-laundering. This was demonstrated in DFP headspace sorption vs. SOA (FIG. 24A) and in DEVX D/E (FIG. 24B) for the pristine, thermally cured and thermally cured/post-laundered samples. Thus, despite the change in fiber morphology, these mats were still suitable for use as a core mitigant layer within a decontaminating material.

### Crosslinking

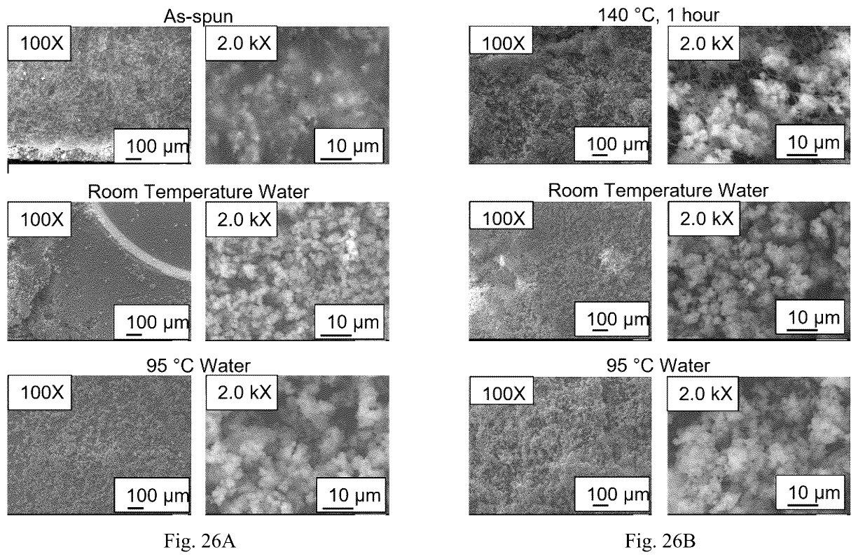

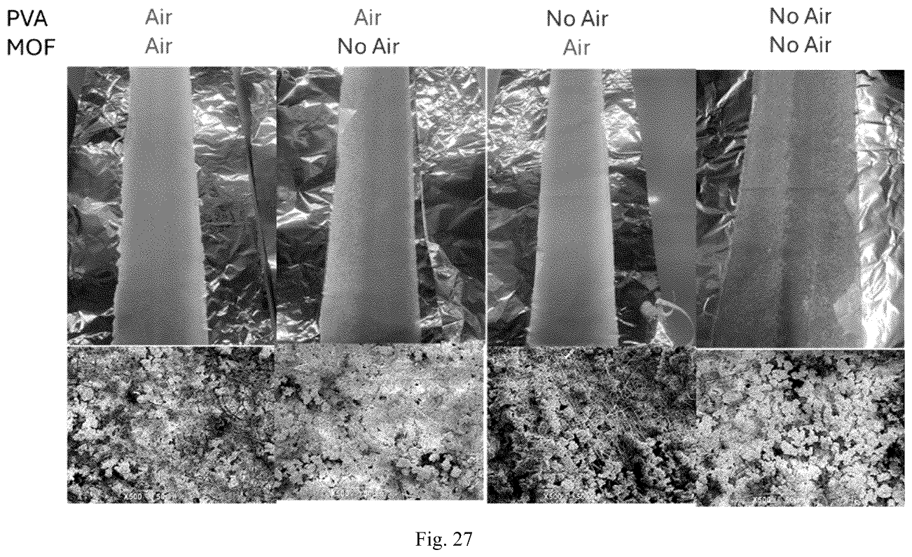

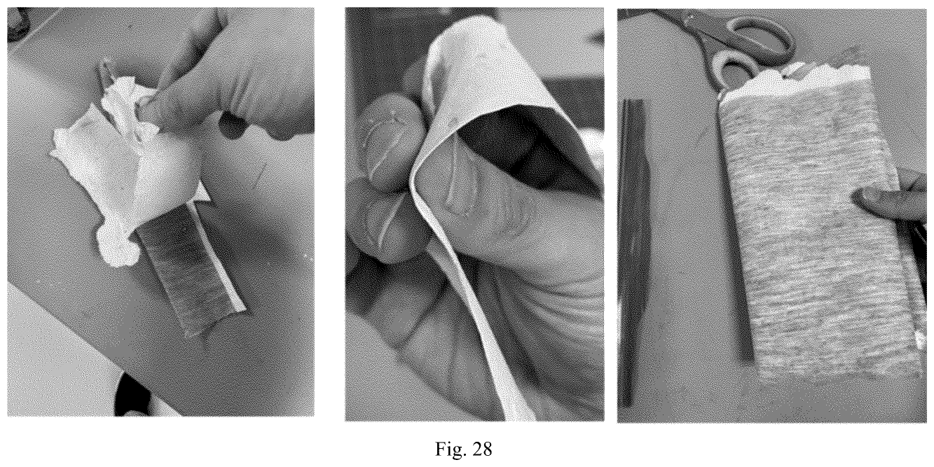

The second method targeted for stabilization of the PVA/UiO-66-NH₂ co-spin/spray mats was through addition of a chemical crosslinker directly within the polymer formulation used in co-spin/spray production. In this case, the type and amount of crosslinker was important, as the UiO-66-NH₂ was susceptible to deactivation upon crosslinker exposure and use of excessive crosslinker within the formulation could have resulted in unacceptably rigid mats. Imprafix 2794, a commercial blocked diisocyanate crosslinker, was initially explored. While it did stabilize the polymer fibers to water exposure, it was ultimately found that the diisocyanate functionality was incompatible with the MOF, and the formulation was abandoned. As an alternative, poly(acrylic acid) (PAA) was evaluated as a PVA crosslinker in place of Imprafix. PAA and PVA are both soluble in water and form miscible solutions when both are dissolved. The acid groups on PAA will crosslink PVA upon heat treatment via esterification. PVA/PAA co-solutions were prepared and electrospun in the presence and absence of co-electrosprayed MOF. Portions of the resulting materials were thermally crosslinked for 1 hour at 130° C. These samples were then exposed as-prepared or as heat treated materials to room temperature and 95° C. water for 5 minutes (FIG. 25). The as-spun PVA-PAA fibers dissolved rapidly upon water exposure, while the heat treated fibers resisted dissolution. The as-spun PVA-PAA-MOF materials showed significant deformation after room temperature water exposure and disintegrated after 95° C. water exposure, leaving behind a small amount of residue. The heat treated PVA-PAA-MOF materials resisted disintegration after water exposure, but delaminated from the foil substrate. FIG. 26 shows the as-spun and heat treated PVA-PAA/MOF materials with and without water exposure, respectively. Large amounts of MOF are visible in all images, but fibers are only present in the samples with no water exposure. There is no observed fiber welding and the materials do not appear to be MOF agglomerates dispersed in a polymer matrix. While the resistance to disintegration shown by the heat treated PVA-PAA/MOF composite is promising, the material and crosslinking method require further optimization.

### Air Assisted Deposition

Further assessments have identified the effects of 15 psi air being enveloped around PVA and MOF for the electrospin/spray fabrication. As shown in FIG. 27, clear macroscopic differences in the dryness and distribution of deposition are shown between air vs. no-air co electrospin/spray process. In general, incorporation of the air with electrospinning/spraying yields drier and stable samples. In addition, the microstructure shows more homogenous fiber and particle deposition, as opposed to clogging and unevenness observed from samples without air employed for both PVA and MOF.

### Composites

In preparation for performance testing against live agents at partner laboratories, PVA/UiO-66-NH₂ composites were fabricated at scale from the binder-free PVA/water and UiO-66-NH₂/IPA formulations at weight ratios of about 1:4 via co-electrospinning-electrospraying at a high mitigant loading (>80 wt % UiO-66-NH₂) on Nomex support material. These samples, exhibited excellent homogeneity, a single layer morphology, minimal mitigant dusting and no wrinkling (FIG. 28). The co-spin/spray mats were cured for 1 hour at 140° C. prior to integration as composites with outer layer materials for composite testing. Results and conclusions from material and composite testing at independent verification and validation (IV&V) laboratories is presented below.

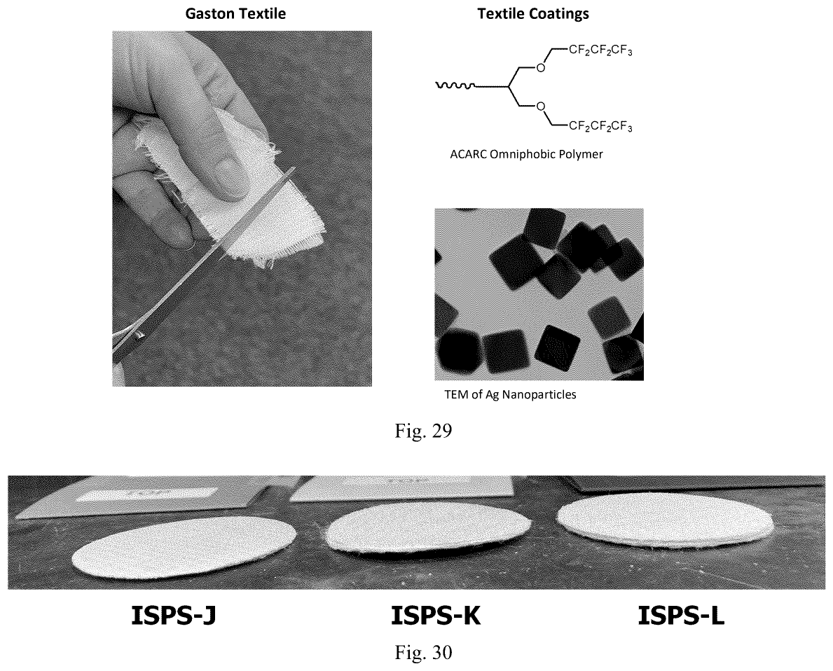

To construct a complete single layer composite, the PVA/MOF mitigant layer required thermal curing to increase water stability, and the top material needed to be effectively adhered to the mitigant layer (achieved with MistyFuse webbing). To ensure that none of these manipulations affected the performance of the composites, each possible permutation of composite construction was tested in a DEVX LVAP experiment, using Gaston 2 as the outer material as shown in FIG. 29. Overall, excellent protection was observed across all sample types tested—neither thermal cross-linking nor adhesion of layers using MistyFuse affected the performance of the composites. Reduced DEVX recovery was observed; this was a function of MOF-mediated simulant decomposition in the mitigant layer. “Gaston 2” is a developmental fabric made by the investigators and is a composition of NyCo (nylon-cotton) material and a Spectra (an ultra-high molecular weight polyethylene fiber) ripstop. “Gaston 1.5” has a similar composition but weighs approximately 1 ozy (ounce per square yard) more than Gaston 2.

Prior to full composite testing, the PVA/MOF mitigant layer was assessed in a dose/extraction experiment with live agents to ensure that the MOF remained active against these threats after both thermal curing and laundering. Indeed, the PVA/MOF mitigant layer MK19 (80 g/m² MOF loading) showed good decontamination of GD (87%) and HD (89%) within 24 h. Importantly, the functionality did not deteriorate after thermal curing or curing/laundering.

Fused ISPS composites constructed according to Table 3 below are shown in FIG. 30.

TABLE 3
ISPS Composites

| Property | ISPS-J | ISPS-K | ISPS-L | SOA |
|---|---|---|---|---|
| Gaston Outer Fabric | 1.5 | 2 | 2 | — |
| Mitigant Loading (g/m²) | 202 | 202 | 254 | 210 |
| Composite Weight | 14.0 | 13.1 | 14.9 | 18.2 |
| Thickness | 1.32 | 1.25 | 1.58 | 1.27 |

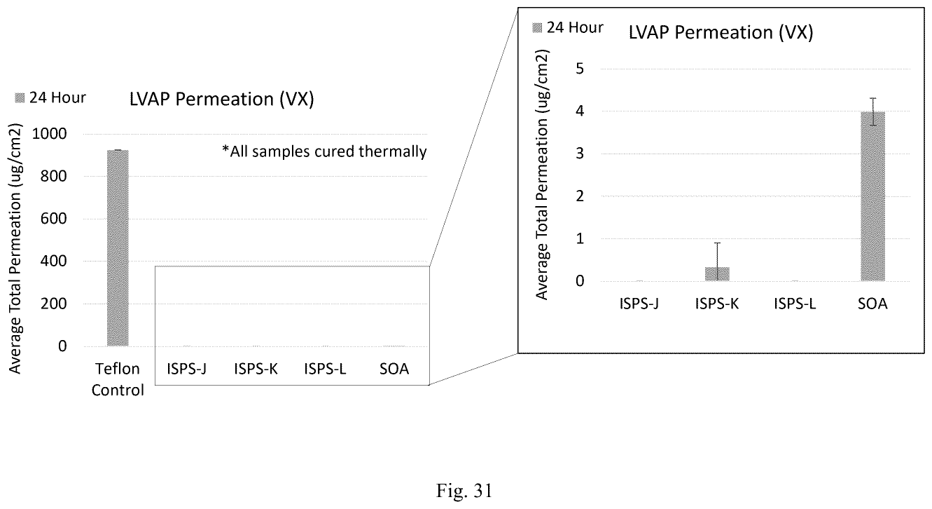

The composites were sent for live agent LVAP testing using VX. These composites were constructed of either Gaston 1.5 or 2 outer materials coated with ACARC-4/Certex (See FIG. 29) and adhered to a thermally cross-linked PVA/MOF mitigant layer on Nomex spunlace backing. The PVA/MOF mitigant layer contained either 200 or 250 g/m² MOF, with the intention of determining what loading was sufficient for protection based on prior data collected. As shown in FIG. 31, all composites, tested in triplicate, exceeded the performance of the SOA. In fact, only a single sample of ISPS-K had detectable breakthrough of VX. ISPS-J and ISPS-L performed better than both the SOA and ISPS-K, with all samples preventing breakthrough of liquid VX beyond the limit of detection for the LVAP test.

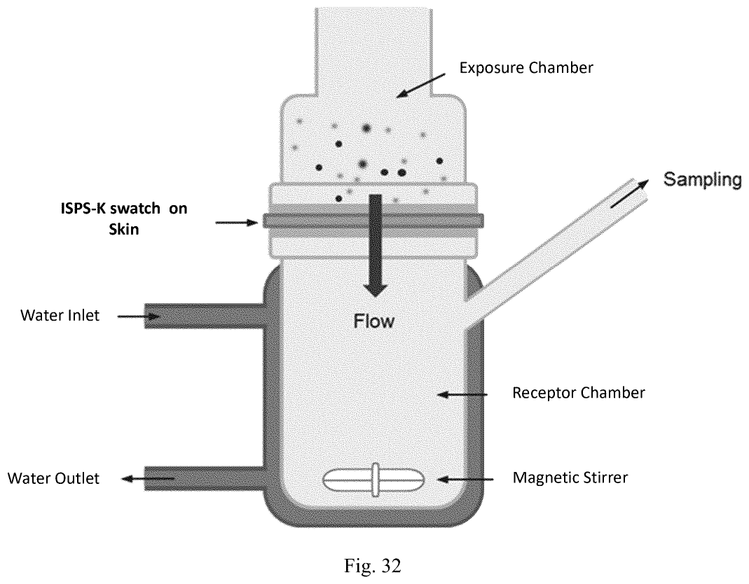

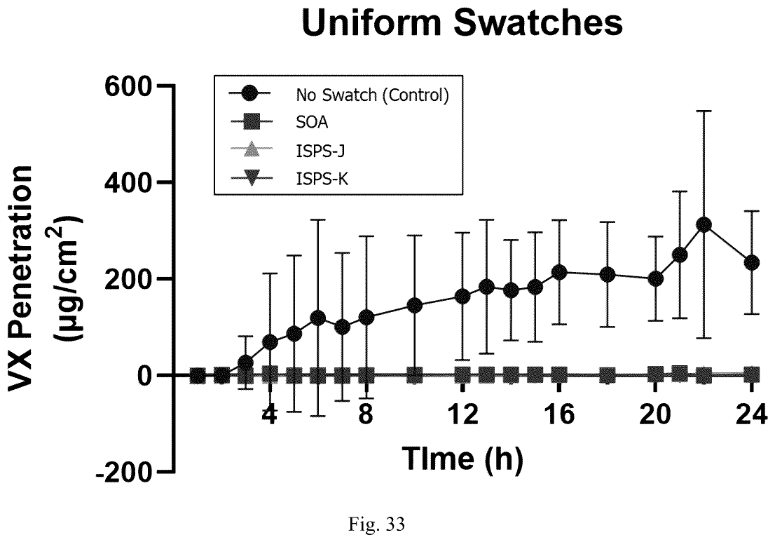

Additional testing on the VX liquid agent permeability profile of the ISPS composites was completed via Franz cell analysis using the setup illustrated in FIG. 32. The Franz analysis assessed the effectiveness of each composite to inhibit chemical penetration through skin. This type of analysis provided additional information beyond that obtained with LVAP and evaluated the contribution of individual composite layers on the overall performance in conjunction with the impact of skin permeability on the protection profile for each sample. Sampling of the liquid media beneath the challenged swatch/skin showed that the ISPS composites (ISPS-J and ISPS-K) performed at least as well as the SOA in preventing penetration of VX through the composite/skin set-up (FIG. 33). Both sample types decreased the penetration of VX as compared to the control where no fabric swatch was applied and VX was dosed directly on to the skin.

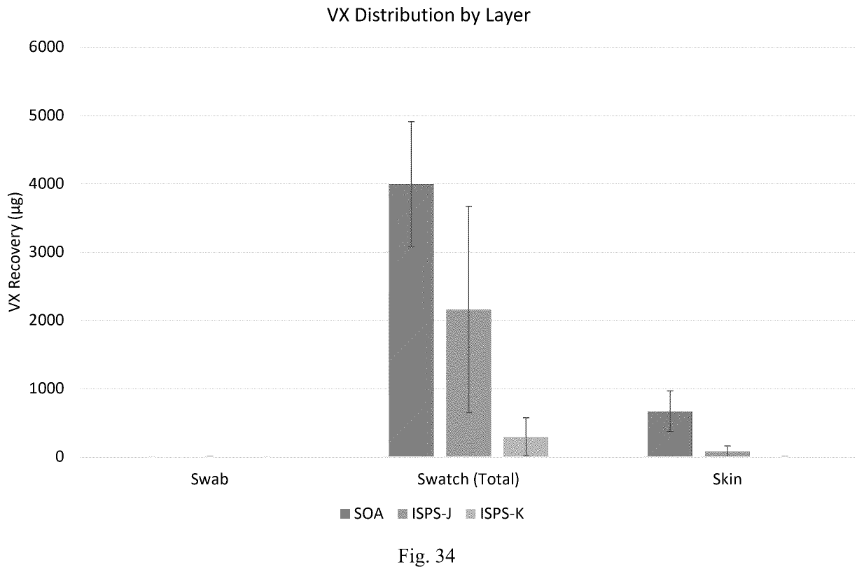

Further analysis of the Franz cell set up was completed to interrogate the distribution of the VX after the 24-hour challenge across the swatch and skin layers. This provided greater detail on the mode of protection for each swatch. Prior to disassembly of the layers the surface of each swatch was swabbed to collect any residual agent that could present a contact hazard. Next, the swatch and skin layers were separated. The swab, swatch, and skin samples were analyzed separately to quantify the VX within each. FIG. 34 summarizes the VX recovery from each sample.

In all cases, minimal agent was found to be residual on the surface of the swatches. ISPS-J showed slightly greater recovery, and therefore potential contact hazard, as compared to ISPS-K and SOA (2.5 μg vs. 0.07 μg and 0.1 μg, respectively), but the differences were not statistically relevant. This general trend was also in agreement with residual contact testing that was done in conjunction with LVAP testing of these samples (ISPS-J 16 μg vs. ISPS-K 10 μg and SOA 5 μg). For all three sample types the majority of VX was retained within the swatch itself.

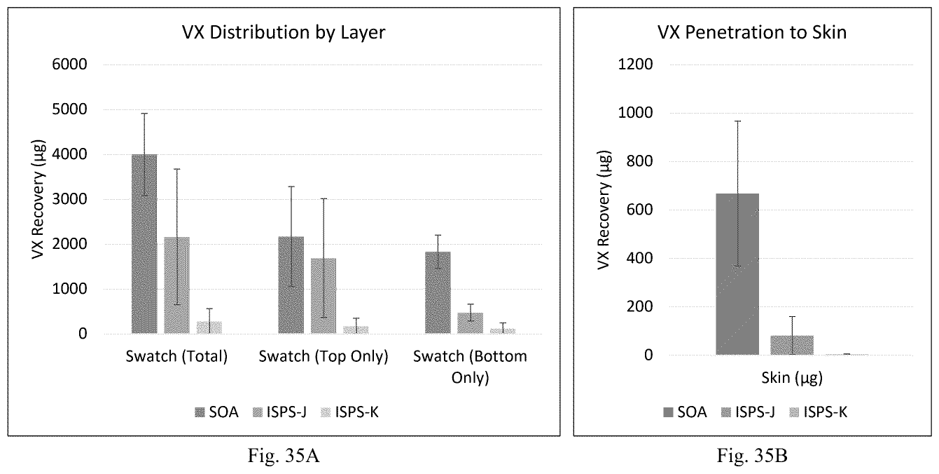

The majority of VX was retained within the swatch for all samples. A marked reduction in VX recovery for ISPS-K was observed as compared to ISPS-J and the SOA. To better understand the origin of this phenomenon, each swatch sample was evaluated by composition for VX sequestration. The SOA is a two-layer system, comprised of top omniphobic “shell” fabric (top) and a “liner” (bottom) which contains carbon-based sorbent. While the material is intended to be a single layer solution it was possible to evaluate the ISPS samples in a direct comparison to the SOA by forgoing the lamination step between the outer omniphobic material (top) and the mitigant layer produced on a material support (bottom). As such, both the SOA and the ISPS samples were disassembled by layer post-Franz cell challenge, and the top and bottom layers were analyzed separately to quantify the VX recovery by layer. FIGS. 35A and 35B summarize the VX recovery from each sample. As compared to ISPS-J and the SOA, the top layer of ISPS-K was significantly lighter in weight (4.5 oz/yd² and 6.2-7.2 oz/yd² vs. 3.5 oz/yd², respectively) and looser in weave and therefore was less capable of acting as a reservoir to hold agent as it permeated into the material. Evidence of this can be seen in FIG. 35A, where the VX recovery for the top swatch of ISPS-K was much less than the top swatches for either ISPS-J or the SOA. As a result of the reduced capacity of the top swatch for ISPS-K it can be inferred that more agent passed directly through to the mitigant layer. The fact that the ISPS-K VX recovery for the bottom swatch in FIG. 35A is equally low demonstrates that the MOF mitigant within the bottom layer performed active decontamination on the agent to neutralize the challenge. This joint action resulted in the reduction of agent in both the top and the bottom layer which led to a significant reduction in the total agent load held within ISPS-K as compared to either ISPS-J or the SOA. ISPS-J also had a reduced agent load as compared to the SOA as a result of the catalytic decontamination function of the MOF mitigant layer, but this was tempered by the fact that the outer layer held agent at levels similar to that of the SOA outer layer.

Evaluation of the skin layers from the Franz cell experiments showed the ultimate impact and benefit of including the MOF as an actual agent detoxifier rather than just agent sorbent within the protective composition. Extraction of the skin layers from the Franz set up showed that despite the liquid sampling results (FIG. 33) suggesting that effective agent protection was equivalent between the ISPS and SOA samples, in fact the ISPS samples provided better protection as compared to the SOA (FIG. 35B). In these tests an average of >650 μg of VX penetrated through the SOA and was recovered from the skin layer. By comparison, approximately 80 μg was recovered for ISPS-J and remarkably only 4 μg, greater than an order of magnitude less than SOA, was recovered for ISPS-K. This amount of agent sequestered within the skin is important as it represents the potential for agent to continually enter into the body even after PPE has been doffed. These results demonstrate a significant improvement in protection that can be achieved by inclusion of catalytic mitigants within PPE despite their greater current cost as compared to existing carbon-based sorbents.

Additional properties of the ISPS-K composite illustrating superior performance in weight, water vapor moisture transport rate, and thermal resistance are shown in Table 4 below.

TABLE 4
ISPS-K Properties

| Property | ISPS-K | SOA |
|---|---|---|
| Composite Weight (oz/yd²) | 13.1 | 18.2 |
| Thickness (mm) | 1.25 | 1.27 |
| MVTR (g/m²/day) | >1000 | 887 |
| Air Permeability (cfu) | ~2 | <6 |
| Filtration Efficiency (300 nm) | >99% | N/A |
| Thermal Resistance (RCF) | <0.04 | 0.058 |

AVLAG permeation tests were performed for the abovementioned ISPS composites along with additional examples listed in Table 5 below.

TABLE 5
ISPS composites for AVLAG testing

| Property | ISPS-J | ISPS-K | ISPS-L | ISPS-A | ISPS-B | ISPS-C | SOA |
|---|---|---|---|---|---|---|---|
| Gaston Outer Fabric | 1.5 | 2 | 2 | 2 | 2 | 2 | — |
| Mitigant Loading | 202 | 202 | 254 | 350 | 420 | 520 | 210 |
| (g/m²) | | | | | | | |
| Composite Weight | 14.0 | 13.1 | 14.9 | 17.8 | 20.0 | 23.3 | 18.2 |
| Thickness | 1.32 | 1.25 | 1.58 | 2.29 | 2.65 | 3.16 | 1.27 |

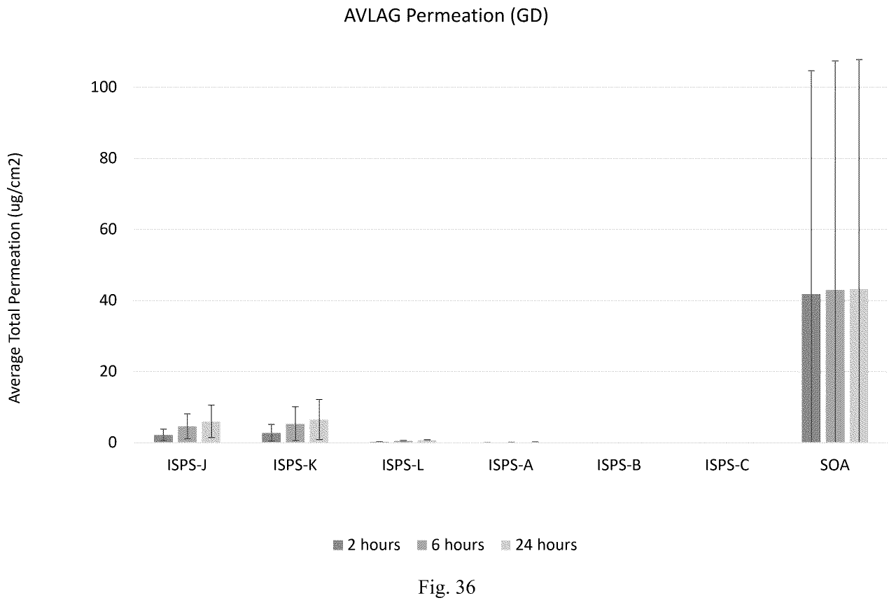

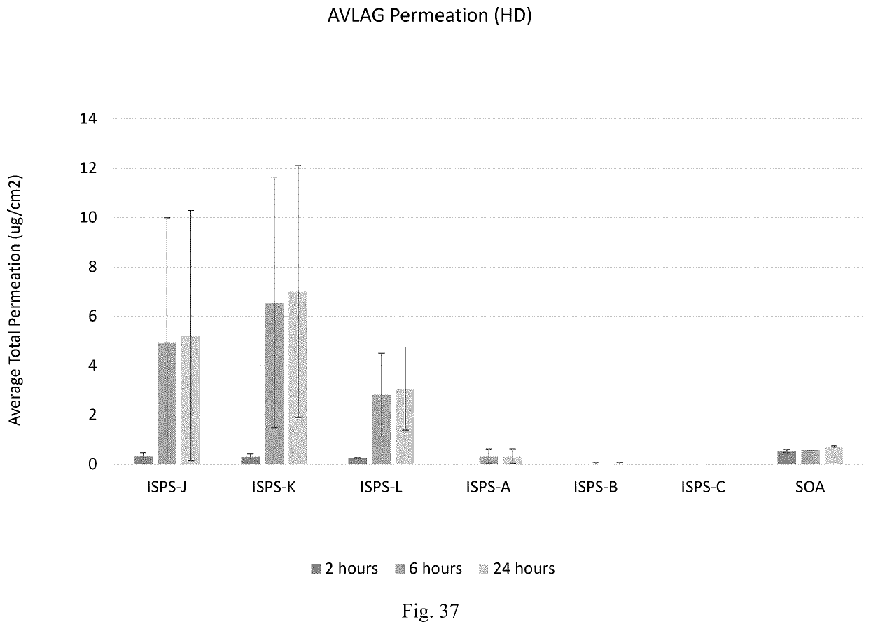

GD and HD were the primary agents evaluated as vapor-phase dermal threats. ISPS composite construction for AVLAG testing against GD and HD was identical to that of LVAP testing (200 and 250 g/m² MOF), but also included three additional mitigant layer loadings (350, 420 and 520 g/m² MOF) to ensure that full vapor protection was achieved. As shown in FIG. 36, while the SOA samples showed a wide variability of GD permeation, all ISPS composites tested showed little to no agent permeation and far exceeded the performance of the SOA at all timepoints tested (2, 6 and 24 h). For HD results shown in FIG. 37, the SOA performed more consistently. Again, all ISPS composites tested were in the protective range, though more variability was observed for the ISPS composite performance than in the GD testing. To be in the range of protection provided by the SOA, 200-250 g/m² MOF was required and was timepoint dependent, with increased variability at the longer timepoints (6 and 24 h). For both GD and HD, it is worth noting that the outer material (Gaston 1.5 or Gaston 2) had minimal impact on the AVLAG results. In summary, ISPS composites containing 200 g/m² MOF provided good protection against GD, while 250 g/m² MOF was better for protection against HD, though 200 g/m² is still near the protection range of the SOA.

### Mechanical Stability

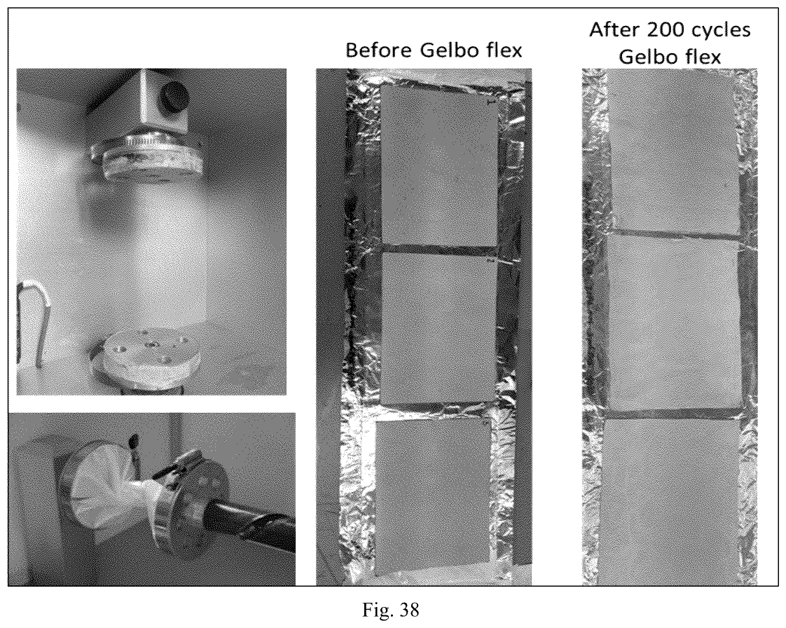

Mechanical stability of the electrospun/sprayed composites were tested using the Gelbo Flex tester, as shown in FIG. 38. As the photos show, there was minimal particle loss nor mechanical tear observed after 200 cycles of Gelbo flex test. This speaks to the mechanical stability of the composite while approaching the MOF loading of approximately 200 g/m². It is believe that other materials configured according to the present disclosure can be mechanically stable after 200 cycles of Gelbo Flex Durability testing according to ASTM F392/F392M (2023). Mechanically stable means the material can be folded, wrinkled, shook, and/or rubbed without significant loss of mitigant particles and tears, holes, or cracked in the material.

Active layers and materials according to the present disclosure have been tested with success against threat agents including nerve agents and mustard agent, for example, GD, GD, VX, A-series agents, and HD. It is anticipated that the materials and active layers will work successfully against any nerve agent class and any mustard type compound.

Although the foregoing description describes multi-layer materials including at least one active layer, it will be understood that the present disclosure also is directed to materials that are active decontaminating materials and lack, for example, a backing layer or a support layer. For example, one such material may consist of an active layer as described herein alone and such materials may be used in applications that do not require a support or backing layer. The principles, observations, comments, etc., herein directed to making and using a multi-layer material comprising at least one active layer may be similarly applied, where pertinent, to making and using an active material lacking support, backing, or other layers, and such active materials and methods of making the same are within the purview of the present disclosure.

Various non-limiting aspects of materials and methods according to the present disclosure are described in the following clauses.

Clause 1. A material comprising at least one active layer, the at least one active layer comprising: a network comprising electrospun polymeric nanofibers, wherein a composition of the polymeric nanofibers comprises a hygroscopic polymer, wherein an area of the active layer is defined by an outer surface of network, and wherein the network comprises a thickness extending normal to the area of the active layer; and at least 50 grams of metal organic framework (MOF) microparticles per m² of the network based on the entire area of the network, wherein the MOF microparticles are configured to decontaminate a chemical threat agent in contact with the active layer, wherein the MOF microparticles are retained between the polymeric nanofibers in the network.

Clause 2. The material of Clause 1, wherein a weight ratio of the polymeric nanofibers to the MOF microparticles in the network is in a range of 1:1 to 1:5 as determined with thermogravimetric analysis.

Clause 3. The material of any of Clauses 1-2, wherein a weight ratio of the polymeric nanofibers to the MOF microparticles in the network is in a range of 1:3 to 1:4.

Clause 4. The material of any of Clauses 1-3, wherein the at least one active layer is configured to be mechanically stable after 200 cycles of Gelbo Flex Durability testing according to ASTM F392/F392M.

Clause 5. The material of any of Clauses 1-4, wherein the thickness of the network spans an entire thickness of the active layer.

Clause 6. The material of any of Clauses 1-5, wherein the at least one active layer is configured to have a weight no greater than 18.0 oz/yd² determined according to ASTM D3776 Option C.

Clause 7. The material of any of Clauses 1-6, wherein the at least one active layer is configured to provide a filtration efficiency of 99% against particles having an average diameter of 300 nm determined according to NIOSH standard.

Clause 8. The material of any of Clauses 1-7, wherein the at least one active layer is configured to provide a water vapor moisture transport rate of 600 g/m²/day or greater, or 1000 g/m²/day or greater, according to ASTM E96 Procedure B (24 h).

Clause 9. The material of any of Clauses 1-8, wherein the at least one active layer is configured to have a thermal resistance of 0.04° C.-m²/W or less according to ASTM F 1868-02.

Clause 10. The material of any of Clauses 1-9, wherein the hygroscopic polymer is polyvinyl alcohol, and wherein the MOF microparticles are based on a UiO-66-NH₂ Zr MOF.

Clause 11. The material of any of Clauses 1-10, wherein the at least one active layer is capable of decontaminating at least 70% of the chemical threat agent as determined with a dose extraction method against a 10 g/m² challenge of the chemical threat agent simulant.

Clause 12. The material of any of Clauses 1-11, wherein the chemical threat agent is DEVX, a simulant of DEVX, or a combination thereof.

Clause 13. The material of any of Clauses 1-12, wherein the at least one active layer is configured to provide an average total gas permeation no greater than 10 micrograms for the chemical threat agent per cm² of active layer based on the area of the active layer as determined according to TOP 8-2-501A.

Clause 14. The material of any of Clauses 1-13, wherein the at least one active layer is configured to provide a Low Volatility Agent Permeation (LVAP) no greater than 1 microgram/cm² for a nerve agent as determined according to TOP 8-2-501A, wherein the LVAP is based on a 10 milligram/m² dosage of the nerve agent.

Clause 15. The material of any of Clauses 1-14, wherein the MOF microparticles are present in the active layer at a loading level of at least 200 grams/m² based on the entire weight of the MOF microparticles and the entire area of the of the active layer.

Clause 16. The material of any of Clauses 1-15, wherein the at least one active layer is configured to have an air permeability of 2 cfm or less as determined according to ASTM D737.

Clause 17. A method for producing a material comprising at least one active layer, the at least one active layer configured to decontaminate a chemical threat agent in contact with the at least one active layer, the method comprising depositing the at least one active layer onto a collector, wherein depositing the at least one active layer comprises: electrospinning, at a first voltage in a range of 30 kV to 50 kV, a first mixture onto the collector, the first mixture comprising 10% by weight to 15% by weight of PVA based on a total weight of the first mixture, wherein the PVA has an average molecular weight in a range of 20,000 g/mol to 300,000 g/mol, wherein the PVA is 99 mol % hydrolyzed based on a total molar amount of PVA in the first mixture, and deionized water; and electrospraying, at a second voltage in a range of 30 kV to 50 kV, a second mixture onto the collector concurrently with electrospinning the first mixture, wherein the second mixture comprises 1% by weight to 5% by weight of MOF microparticles based on the total weight of the second mixture, wherein the MOF microparticles comprise UiO-66-NH₂, and isopropyl alcohol; and wherein at least one of electrospinning the first mixture or electrospraying the second mixture is an air-assisted process.

Clause 18. The method of Clause 17, wherein: electrospinning the first mixture comprises pumping the first mixture through a first needle to produce a first charged stream, and combining the first charged stream with a first air stream, wherein the first charged stream exiting the first needle is coaxially positioned within the first air stream, and wherein a pressure of the first air stream is in a range of 3 psig to 7 psig; and electrospraying the second mixture comprises pumping the second mixture through a second needle to produce a second charged stream and combining the second charged stream with a second air stream, wherein the second charged stream exiting the second needle is coaxially positioned within the second air stream, and wherein a pressure of the second air stream is in a range of 12 psig to 20 psig; and wherein the first voltage and the second voltage are provided by a common power source.

Clause 19. The method of Clause 18, wherein a flowrate of the first charged stream is in a range of 1 mL/hour to 5 mL/hour and a flowrate of the second charged stream is in a range of 10 mL/hour to 40 mL/hour.

Clause 20. The method of any of Clauses 17-19, the method further comprising thermally curing the deposited active layer for at least 1 hour at 140° C.

Clause 21. A material comprising: a network comprising electrospun polymeric nanofibers, wherein a composition of the polymeric nanofibers comprises a hygroscopic polymer, wherein an area of the material is defined by an outer surface of the network, and wherein the network comprises a thickness extending normal to the area of material; and at least 50 grams of metal organic framework (MOF) microparticles per m² of the network based on the entire area of the network, wherein the MOF microparticles are configured to decontaminate a chemical threat agent in contact with the material, wherein the MOF microparticles are retained between the polymeric nanofibers in the network.

Clause 22. The material of Clause 21, wherein a weight ratio of the polymeric nanofibers to the MOF microparticles in the network is in a range of 1:1 to 1:5 as determined with thermogravimetric analysis.

Clause 23. The material of any of Clauses 21 and 22, wherein a weight ratio of the polymeric nanofibers to the MOF microparticles in the network is in a range of 1:3 to 1:4.

Clause 24. The material of any of Clauses 21-23, wherein the material is configured to be mechanically stable after 200 cycles of Gelbo Flex Durability testing according to ASTM F392/F392M.

Clause 25. The material of any of Clauses 21-24, wherein the thickness of the network spans an entire thickness of the material.

Clause 26. The material of any of Clauses 21-25, wherein the hygroscopic polymer is polyvinyl alcohol, and wherein the MOF microparticles are based on a UiO-66-NH₂ Zr MOF.

Clause 27. The material of any of Clauses 21-26, wherein the material is capable of decontaminating at least 70% of a chemical threat agent as determined with a dose extraction method against a 10 g/m² challenge of the chemical threat agent simulant.

Clause 28. The material of any of Clauses 21-27, wherein the chemical threat agent is DEVX, a simulant of DEVX, or a combination thereof.

Clause 29. The material of any of Clauses 21-28, wherein material is configured to provide an average total gas permeation no greater than 10 micrograms for the chemical threat agent per cm² of active layer based on the area of the material as determined according to TOP 8-2-501A.

Clause 30. The material of any of Clauses 21-29, wherein the material is configured to provide a Low Volatility Agent Permeation (LVAP) no greater than 1 microgram/cm² for a nerve agent as determined according to TOP 8-2-501A, wherein the LVAP is based on a 10 milligram/m² dosage of the nerve agent.

Clause 31. The material of any of Clauses 21-30, wherein the MOF microparticles are present in the material at a loading level of at least 200 grams/m² based on the entire weight of the MOF microparticles and the entire area of the material.

Clause 32. A method for producing a material, the material configured to decontaminate a chemical threat agent in contact with the material, the method comprising depositing the material onto a collector, wherein depositing the material comprises: electrospinning, at a first voltage in a range of 30 kV to 50 kV, a first mixture onto the collector, the first mixture comprising 10% by weight to 15% by weight of PVA based on a total weight of the first mixture, wherein the PVA has an average molecular weight in a range of 20,000 g/mol to 300,000 g/mol, wherein the PVA is 99 mol % hydrolyzed based on a total molar amount of PVA in the first mixture, and deionized water; and electrospraying, at a second voltage in a range of 30 kV to 50 kV, a second mixture onto the collector concurrently with electrospinning the first mixture, wherein the second mixture comprises 1% by weight to 5% by weight of MOF microparticles based on the total weight of the second mixture, wherein the MOF microparticles comprise UiO-66-NH₂, and isopropyl alcohol; and wherein at least one of electrospinning the first mixture or electrospraying the second mixture is an air-assisted process.

Clause 33. The method of Clause 32, wherein: electrospinning the first mixture comprises pumping the first mixture through a first needle to produce a first charged stream and combining the first charged stream with a first air stream, wherein the first charged stream exiting the first needle is coaxially positioned within the first air stream, and wherein a pressure of the first air stream is in a range of 3 psig to 7 psig; and electrospraying the second mixture comprises pumping the second mixture through a second needle to produce a second charged stream and combining the second charged stream with a second air stream, wherein the second charged stream exiting the second needle is coaxially positioned within the second air stream, and wherein a pressure of the second air stream is in a range of 12 psig to 20 psig; and wherein the first voltage and the second voltage are provided by a common power source.

Clause 34. The method of Clause 33, wherein a flowrate of the first charged stream is in a range of 1 mL/hour to 5 mL/hour and a flowrate of the second charged stream is in a range of 10 mL/hour to 40 mL/hour.

Clause 35. The method of any of Clauses 31-34, the method further comprising thermally curing the deposited material for at least 1 hour at 140° C.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” or the symbol “-” may be used to mean within ±20% of a target value in some embodiments, within ±10% of a target value in some embodiments, within +5% of a target value in some embodiments, and yet within +2% of a target value in some embodiments. The terms “approximately” and “about” or the symbol “˜” may include the target value.

In the claims, as well as in the specification above, all transitional phrases such as “comprising”, “including”, “carrying”, “having”, “containing”, “involving”, “holding”, “composed of”, and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112(f). Absent a recital of “means for” in the claims, such claims should not be construed under 35 USC 112. Limitations from the specification are not intended to be read into any claims unless such limitations are expressly included in the claims.

What is claimed is:

1. A material comprising:
a network comprising electrospun polymeric nanofibers, wherein a composition of the polymeric nanofibers comprises a hygroscopic polymer, wherein an area of the material is defined by an outer surface of the network; and
at least 50 grams of metal organic framework (MOF) microparticles per m² of the network based on an entire area of the network, wherein the MOF microparticles are configured to decontaminate a chemical threat agent in contact with the material, wherein the MOF microparticles are retained between the polymeric nanofibers in the network.

2. The material of claim 1, wherein a weight ratio of the polymeric nanofibers to the MOF microparticles in the network is in a range of 1:1 to 1:5 as determined with thermogravimetric analysis.

3. The material of claim 1, wherein a weight ratio of the polymeric nanofibers to the MOF microparticles in the network is in a range of 1:3 to 1:4 as determined with thermogravimetric analysis.

4. The material of claim 1, wherein the material is configured to be mechanically stable after 200 cycles of Gelbo Flex Durability testing according to ASTM F392/F392M (2023).

5. The material of claim 1, wherein a thickness of the network extending normal to the area of material spans an entire thickness of the material.

6. The material of claim 1, wherein a thickness of the network extending normal to the area of material spans greater than an entire thickness of the material.

7. The material of claim 1, wherein the material is configured to have a weight no greater than 18.0 oz/yd² determined according to ASTM D3776 Option C.

8. The material of claim 1, wherein the material is configured to provide a filtration efficiency of 99% or greater against particles having an average diameter of 300 nm determined according to a NIOSH standard.

9. The material of claim 1, wherein the material is configured to provide a water vapor moisture transport rate of 600 g/m²/day or greater according to ASTM E96 Procedure B (24 h).

10. The material of claim 1, wherein the hygroscopic polymer is polyvinyl alcohol, and wherein the MOF microparticles are based on a UiO-66-NH₂ Zr MOF.

11. The material of claim 1, wherein the material is capable of decontaminating at least 70% of the chemical threat agent as determined with a dose extraction method against a 10 g/m² challenge of the chemical threat agent.

12. The material of claim 11, wherein the chemical threat agent is DEVX, a simulant of DEVX, or a combination thereof.

13. The material of claim 1, wherein the material is configured to provide an average total gas permeation no greater than 10 micrograms for the chemical threat agent per cm² of material based on the area of the material as determined according to TOP 8-2-501A.

14. The material of claim 1, wherein the material is configured to provide a Low Volatility Agent Permeation (LVAP) no greater than 1 microgram/cm² for a nerve agent as determined according to TOP 8-2-501A, wherein the LVAP is based on a 10 milligram/m² dosage of the nerve agent.

15. The material of claim 1, wherein the MOF microparticles are present in the material at a loading level of at least 200 grams MOF per m² of the material.

16. A method for producing a material, the material configured to decontaminate a chemical threat agent in contact with the material, the method comprising depositing the material onto a collector, wherein depositing the material comprises:
electrospinning, at a first voltage in a range of 15 kV to 50 kV, a first mixture onto the collector, the first mixture comprising:
PVA having an average molecular weight in a range of 20,000 g/mol to 300,000 g/mol; and
water; and
electrospraying, at a second voltage in a range of 15 kV to 50 kV, a second mixture onto the collector concurrently with electrospinning the first mixture, wherein the second mixture comprises:
MOF microparticles; and
water miscible solvent;
wherein electrospinning the first mixture, electrospraying the second mixture, or both electrospinning the first mixture and electrospraying the second mixture comprise an air-assisted process.

17. The method of claim 16, wherein:
electrospinning the first mixture comprises:
pumping the first mixture through a first needle to produce a first charged stream; and
combining the first charged stream with a first air stream, wherein the first charged stream exiting the first needle is coaxially positioned within the first air stream; and
electrospraying the second mixture comprises:
pumping the second mixture through a second needle to produce a second charged stream; and
combining the second charged stream with a second air stream, wherein the second charged stream exiting the second needle is coaxially positioned within the second air stream.

18. The method of claim 17, wherein a pressure of the first air stream is in a range of 3 psig to 7 psig and a pressure of the second air stream is in a range of 12 psig to 20 psig.

19. The method of claim 17, wherein a flowrate of the first charged stream is in a range of 1 mL/hour to 5 mL/hour and a flowrate of the second charged stream is in a range of 10 mL/hour to 40 mL/hour.

20. The method of claim 16, the method further comprising thermally curing the deposited material for at least 1 hour at 140° C.
